(19) United States
(12) Patent Application Publication
(10) Pub. No.: US 2011/0229049 A1
(43) Pub. Date: Sep. 22, 2011

(54) IMAGE PROCESSING APPARATUS, IMAGE PROCESSING METHOD, AND PROGRAM

(75) Inventor: Kenji Kondo, Tokyo (JP)

(73) Assignee: Sony Corporation, Tokyo (JP)

(21) Appl. No.: 13/130,682

(22) PCT Filed: Dec. 3, 2009
(86) PCT No.: PCT/JP2009/070294

§ 371 Date: May 23, 2011

(30) Foreign Application Priority Data
Dec. 3, 2008 (JP) 2008-308217

(51) Int. Cl. G06K 9/46

(52) U.S. Cl. 382/233

(57) ABSTRACT

The present invention relates to an image processing apparatus, an image processing method, and a program capable of increasing the quality of an inter predicted image.

A computing unit 115 performs decoding by adding a transform coefficient transmitted from an inverse orthogonal transform unit 114 after inverse orthogonal transform is performed to an inter predicted image supplied from a switch 214. A motion prediction/compensation unit 212 performs motion compensation on the decoded image on the basis of blur information that corresponds to a compressed image and that is transmitted from an image encoding apparatus. A blur prediction/compensation unit 213 performs blur compensation on the motion-compensated image and supplies the resultant motion compensated and blur compensated image to the switch 214 as the inter predicted image. The present invention is applicable to an image decoding apparatus that performs decoding using, for example, the H.264/AVC standard.

### TECHNICAL FIELD

The present invention relates to an image processing apparatus, an image processing method, and a program and in particular, to an image processing apparatus, an image processing method, and a program capable of increasing the quality of a prediction image generated through inter prediction.

### BACKGROUND ART

In recent years, apparatuses that manipulate image information in a digital format and, at that time, in order to transfer and accumulate the information efficiently, compression-encode an image have been in widespread use. The apparatuses use the redundancy that is specific to image information and employ a method for compressing the image on the basis of orthogonal transform, such as discrete cosine transform, and motion compensation (e.g., the MPEG (Moving Picture Experts Group phase) standard).

In particular, MPEG2 (ISO/IEC 13818-2) is defined as a general-purpose image encoding method. MPEG2 is a standard defined for interlacing scanned images and progressive scanned images and for standard-definition images and high-definition images. MPEG2 is widely used for professional and consumer applications nowadays. By using the MPEG2 compression standard and assigning an amount of coding (a bit rate) of 4 to 8 Mbps to a standard resolution interlacing image of 720×480 pixels and an amount of coding of 18 to 22 Mbps to a high-definition interlacing image of 1920×1088 pixels, a high compression ratio and an excellent image quality can be realized.

MPEG2 is intended to provide high-resolution encoding that mainly accommodates with broadcasting and, thus, MPEG2 does not support a coding method having an amount of coding lower than that of MPEG1, that is, a compression ratio higher than that of MPEG1. However, as cell phones are becoming more widely used, the need for such an encoding method is increasing. Accordingly, the MPEG4 coding method has been standardized. For example, the MPEG4 image coding method was approved as the international standard ISO/IEC 14496-2 in December, 1998.

In addition, in recent years, in order to encode an image for TV conferences, standardization of the standard called H.26L (ITU-T Q6/16 VCEG) has been progressing. In H.26L, a large amount of computation is required for encoding and decoding operations, as compared with existing coding standards, such as MPEG2 and MPEG4. However, it is known that H.26L can realize a higher coding efficiency. Furthermore, standardization called Joint Model of Enhanced-Compression Video Coding has been progressing as part of the activities of MPEG4. The Joint Model of Enhanced-Compression Video Coding is based on H.26L and includes functions that are not supported by H.26L and, thus, a higher coding efficiency can be realized. The Joint Model of Enhanced-Compression Video Coding was approved as an international standard in March, 2003, as H.264 and MPEG-4 Part 10 (Advanced Video Coding; Hereinafter, referred to as “AVC”).

In addition, for example, in H.264/AVC, inter prediction is performed using a correlation between frames or fields. In a motion compensation process performed in such inter prediction, a predicted image is generated through inter prediction (hereinafter referred to as an “inter predicted image”) by translating a motion compensation block representing a partial area of a reference image. More specifically, an inter predicted image is generated by translating the pixel values in the motion compensation block in accordance with a motion vector representing the motion between frames or fields.

For example, as shown in “A” of FIG. 1, if a face 11 in the image of a (t−1)th frame is translated to the right in the image of a tth frame, the image of the (t−1)th frame is defined as a reference image in a motion compensation process, as shown in “B” of FIG. 1. Thus, a motion vector indicating the right direction is obtained. Thereafter, as shown in “B” of FIG. 1, a motion compensation block 12 including the face 11 in the reference image is translated to the right in accordance with the motion vector. Such an image is generated as an inter predicted image in the tth frame.

Note that for simplicity, in FIG. 1, inter prediction is performed using two frames: the (t−1)th frame and tth frame. However, in reality, the number of frames used is not limited to 2.

In addition, in a motion compensation process of H.264/AVC, the resolution for a motion vector can be increased to fractional-pel accuracy, such as ½-pel accuracy or ¼-pel accuracy.

In such a compensation process with fractional pixel accuracy, a virtual pixel called a Sub-Pel is assumed to exist between two neighboring pixels, and a process for generating the Sub-Pel (hereinafter referred to as “interpolation”) is additionally performed.

For example, an FIR (Finit-duration Impulse Response) filter is used for interpolation. This FIR filter interpolates data between two neighboring pixels. Accordingly, the number of taps of the FIR filter is even. For example, in H.264/AVC, the number of taps of a FIR filter for a motion compensation process with ½-pixel accuracy is 6. The number of taps of a FIR filter for a motion compensation process with ¼-pixel accuracy is 2.

However, in a motion compensation process with a fractional pixel accuracy using a FIR filter, only interpolation is additionally performed. Like the motion compensation process with an integer-pixel accuracy, an inter predicted image is generated by translating a motion compensation block.

In addition, NPLs 1 and 2 describe an adaptive interpolation filter (AIF) reported in a recent research paper. In such motion compensation processes using an AIF, by adaptively changing the filter coefficient of an FIR filter having an even number of taps used in interpolation, the aliasing effect can be reduced and, therefore, an error in motion compensation can be reduced.

However, in motion compensation with fractional-pel accuracy using an AIF, interpolation is performed by only adaptively changing the filter coefficient of an FIR filter. Like motion compensation with integer pel accuracy, a motion compensation block is translated, and an inter predicted image is generated.

As described above, a motion compensation process with integer pel accuracy and a motion compensation process with fractional-pel accuracy using an FIR filter or an AIF can be performed when a change in an image is expressed as translation of the image.

### CITATION LIST

### Non Patent Literature

NPL 1: Thomas Wedi and Hans Georg Musmann, Motion- and Aliasing-Compensated Prediction for Hybrid Video Coding, IEEE Transactions on circuits and systems for video technology, July 2003, Vol. 13, No. 7
NPL 2: Yuri Vatis, Joern Ostermann, Prediction of P- and B-Frames Using a Two-dimensional Non-separable Adaptive Wiener Interpolation Filter for H.264/AVC, ITU-T SG16 VCEG 30th Meeting, Hangzhou China, October 2006

### SUMMARY OF INVENTION

### Technical Problem

However, in reality, a change in an image cannot be expressed as only translation. For example, an amount of blur of an image may change due to a variety of reasons (e.g., going out of focus from an in-focus state, coming into focus from an out-of-focus state, or an object moves at an accelerated rate). As used herein, the term “blur” refers to ambiguity of the position of an object in an image. An object that appears in an image in the form of spot light when the object is not blurred appears in the form of diffuse light if the object is blurred.

If such blur occurs, a high frequency component of an image is lost. However, a variation in the frequency characteristic cannot be expressed using translation. Therefore, when a change in blur occurs between images and if inter prediction is performed using the above-described motion compensation process, a difference in a pixel value between an inter predicted image and an image to be encoded is generated. Note that this difference decreases the peak signal noise ratio (PSNR) of the inter predicted image with respect to the image to be encoded.

For example, as shown in FIG. 2, if an input in-focus image of a (t−1)th frame is changed to an input out-of-focus image of a tth frame, a non-blurred face 21 in the input image of the (t−1)th frame is changed to a blurred face 22 in the input image of the tth frame. Note that in FIG. 2, blur is represented by a bold outline. In addition, in the example in FIG. 2, for simplicity, the face 21 is stationary.

In such a case, the motion vector for the face 21 is 0. Accordingly, as shown in FIG. 2, when the input image of the (t−1)th frame is defined as a reference image and if inter prediction is performed for the tth frame to be encoded, the inter predicted image of the tth frame is the same as the reference image. That is, a face in the inter predicted image of the tth frame is the same as the non-blurred face 21 in the input image of the (t−1)th frame.

Accordingly, in terms of pixel values, only a difference between the face 22 and the face 21 occurs between the inter predicted image of the tth frame and the input image. Thus, the PSNR of the inter predicted image with respect to the input image of the tth frame is decreased. That is, as shown in FIG. 2, a difference image between the inter predicted image and an input image of the tth frame is an image in which an outline portion 23 of the face 21 remains as a difference between the face 22 and the face 21.

Note that in the example shown in FIG. 2, the face 21 is stationary. However, even for the face 21 that is moving, in terms of pixel values, only a difference between the face 22 and the face 21 similarly occurs between the inter predicted image of the tth frame and the input image. Therefore, the PSNR of the inter predicted image with respect to the input image of the tth frame is decreased.

In an encoding apparatus, in general, a difference image is subjected to some orthogonal transform, quantization, and encoding. Thereafter, the resultant image is transferred to a decoder as an encoded image. Accordingly, a decrease in the PSNR increases the amount of coding and decreases the coding efficiency.

Accordingly, the present invention can increase the quality of an inter predicted image.

### Solution to Problem

According to a first aspect of the present invention, an image processing apparatus includes decoding means for decoding an encoded image, compensating means for performing motion compensation and blur compensation on the image decoded by the decoding means on the basis of blur information indicating a variation in blur between images, where the blur information corresponds to the encoded image and is transmitted from a different image processing apparatus that has encoded the image, and computing means for generating a decoded image by summing the image decoded by the decoding means and a compensated image subjected to motion compensation and the blur compensation performed by the compensating means.

The blur information can be expressed using a PSF (Point Spread Function).

The blur information can be expressed using a two-dimensional normal distribution expression.

The blur information transmitted from a different image processing apparatus can indicate a spreading width W of the two-dimensional normal distribution expression.

The blur information can be expressed by a radius L output as an impulse response.

The blur information can be expressed by a length Lx in a horizontal direction and a length Ly in a vertical direction from a center as an impulse response.

The compensating means can perform the motion compensation on the image decoded by the decoding means and performs the blur compensation on the resultant image using the blur information.

The compensating means can perform the blur compensation on the image decoded by the decoding means using the blur information and performs the motion compensation on the resultant image.

According to the first aspect of the present invention, an image processing method for use in an image processing apparatus is provided. The method includes a decoding step of decoding an encoded image, a compensating step of performing motion compensation and blur compensation on the image decoded in the decoding step on the basis of blur information indicating a variation in blur between images, where the blur information corresponds to the encoded image and is transmitted from a different image processing apparatus that has encoded the image, and a computing step of generating a decoded image by summing the image decoded in the decoding step and a compensated image subjected to motion compensation and blur compensation performed in the compensating step.

According to the first aspect of the present invention, a program includes program code for causing a computer to function as an image processing apparatus. The image processing apparatus includes decoding means for decoding an encoded image, compensating means for performing motion compensation and blur compensation on the image decoded by the decoding means on the basis of blur information indicating a variation in blur between images, where the blur information corresponds to the encoded image and is transmitted from a different image processing apparatus that has encoded the image, and computing means for generating a decoded image by summing the image decoded by the decoding means and a compensated image subjected to motion compensation and blur compensation performed by the compensating means.

According to a second aspect of the present invention, an image processing apparatus includes compensating means for predicting, using an image to be encoded and a reference image, motion and a variation in blur between the image to be encoded and the reference image and performing motion compensation and blur compensation on the reference image on the basis of a motion vector representing the motion and blur information indicating the variation in blur, encoding means for generating an encoded image using a difference between a compensated image subjected to the motion compensation and the blur compensation and the image to be encoded, and transmitting means for transmitting the encoded image and the blur information.

The blur information can be expressed by a PSF (Point Spread Function).

The blur information can be expressed using a two-dimensional normal distribution expression.

The transmitting means can transmit a spreading width W of the two-dimensional normal distribution expression as the blur information.

The blur information can be expressed by a radius L output as an impulse response.

The blur information can be expressed by a length Lx in a horizontal direction and a length Ly in a vertical direction from a center as an impulse response.

The motion can be predicted using the image to be encoded and the reference image, and the motion compensation can be performed on the basis of a motion vector representing the motion. The variation in blur can be predicted using the image obtained through the motion compensation and the image to be encoded, and the blur compensation can be performed on the basis of blur information representing the variation in blur.

The compensating means can predict the variation in blur using the image to be encoded and the reference image and perform the blur compensation on the basis of blur information representing the variation in blur, and the compensating means can predict the motion using the image obtained through the blur compensation and the image to be encoded and perform the motion compensation on the basis of a motion vector representing the motion.

According to the second aspect of the present invention, an image processing method for use in an image processing apparatus is provided. The method includes a compensating step of predicting, using an image to be encoded and a reference image, motion and a variation in blur between the image to be encoded and the reference image and performing motion compensation and blur compensation on the basis of a motion vector representing the motion and blur information indicating the variation in blur, an encoding step of generating an encoded image using a difference between a compensated image subjected to the motion compensation and the blur compensation and the image to be encoded, and a transmitting step of transmitting the encoded image and the blur information.

According to the second aspect of the present invention, a program includes program code for causing a computer to function as an image processing apparatus. The image processing apparatus includes compensating means for predicting, using an image to be encoded and a reference image, motion and a variation in blur between the image to be encoded and the reference image and performing motion compensation and blur compensation on the basis of a motion vector representing the motion and blur information indicating the variation in blur, encoding means for generating an encoded image using a difference between a compensated image subjected to the motion compensation and the blur compensation and the image to be encoded, and transmitting means for transmitting the encoded image and the blur information.

According to the first aspect of the present invention, an encoded image is decoded. Motion compensation and blur compensation are performed on the decoded image on the basis of blur information corresponding to the encoded image and transmitted from a different image processing apparatus that encoded the image, where the blur information indicates a variation in blur between images. Thereafter, a decoded image is generated by summing the decoded image and the compensated image subjected to the motion compensation and blur compensation performed by the compensating means.

According to the second aspect of the present invention, using an image to be encoded and the reference image, motion and a variation in blur between the image to be encoded and the reference image is predicted, and motion compensation and blur compensation are performed on the reference image on the basis of a motion vector representing the motion and blur information indicating the variation in blur. Thereafter, an encoded image is generated using a difference between a compensated image subjected to the motion compensation and the blur compensation and the image to be encoded. Subsequently, the encoded image and the blur information are transmitted.

### Advantageous Effects of Invention

According to the present invention, the quality of an inter predicted image can be increased.

### BRIEF DESCRIPTION OF DRAWINGS

FIG. 1 illustrates an existing inter prediction technique.

FIG. 2 illustrates an intra predicted image obtained when blur occurs between images.

FIG. 3 is a block diagram of the configuration of an image encoding apparatus according to the present invention.

FIG. 4 illustrates a variable block size.

FIG. 5 is a block diagram of the configuration of an image decoding apparatus according to the present invention.

FIG. 6 is a block diagram of an example of the configuration of an image encoding apparatus according to a first embodiment of the present invention.

FIG. 7 is a block diagram of a detailed configuration example of a blur prediction/compensation unit shown in FIG. 6.

FIG. 8 illustrates a mechanism through which focus blur occurs.

FIG. 9 illustrates a mechanism through which motion blur occurs.

FIG. 10 illustrates blur information regarding focus blur.

FIG. 11 illustrates blur information regarding motion blur.

FIG. 12 illustrates a point spread function.

FIG. 13 illustrates a point spread function.

FIG. 14 illustrates an example of filter coefficients computed using a normal distribution equation.

FIG. 15 is a flowchart of an encoding process performed by the image encoding apparatus shown in FIG. 6.

FIG. 16 is a flowchart of a blur prediction/compensation process performed in step S25 shown in FIG. 15.

FIG. 17 is a block diagram of an example configuration of an image decoding apparatus according to the first embodiment of the present invention.

FIG. 18 illustrates an example of the detailed configuration of a blur prediction/compensation unit shown in FIG. 17.

FIG. 19 is a flowchart of a decoding process performed by the image decoding apparatus shown in FIG. 17.

FIG. 20 is a flowchart of a blur compensation process performed in step S140 shown in FIG. 19.

FIG. 21 is a block diagram of an example of the configuration of an image encoding apparatus according to a second embodiment of the present invention.

FIG. 22 is a block diagram of an example of the detailed configuration of a blur motion prediction/compensation unit shown in FIG. 21.

FIG. 23 is a flowchart of an encoding process performed by the image encoding apparatus shown in FIG. 21.

FIG. 24 is a flowchart of a blur motion prediction/compensation process performed in step S223 shown in FIG. 23.

FIG. 25 is a block diagram of an example configuration of an image decoding apparatus according to a second embodiment of the present invention.

FIG. 26 is a block diagram of a detailed example configuration of a blur motion prediction/compensation unit shown in FIG. 25.

FIG. 27 is a flowchart of a decoding process performed by the image decoding apparatus shown in FIG. 25.

FIG. 28 is a flowchart of a blur motion compensation process performed in step S339 shown in FIG. 27.

FIG. 29 illustrates an example of an extended macroblock size.

FIG. 30 is a block diagram of an example of the primary configuration of a television receiver according to the present invention.

FIG. 31 is a block diagram of an example of the primary configuration of a cell phone according to the present invention.

FIG. 32 is a block diagram of an example of the primary configuration of a hard disk recorder according to the present invention.

FIG. 33 is a block diagram of an example of the primary configuration of a camera according to the present invention.

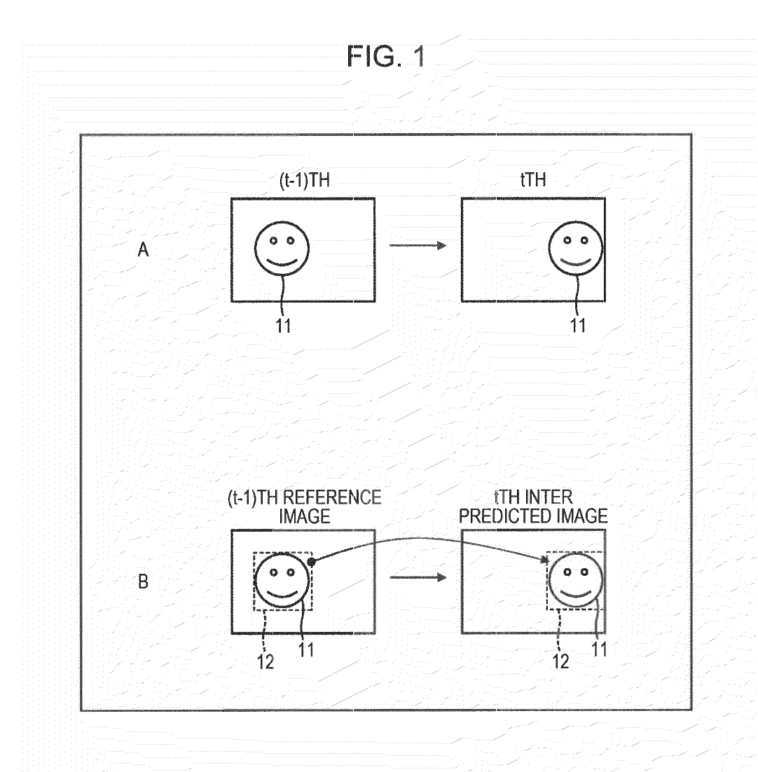

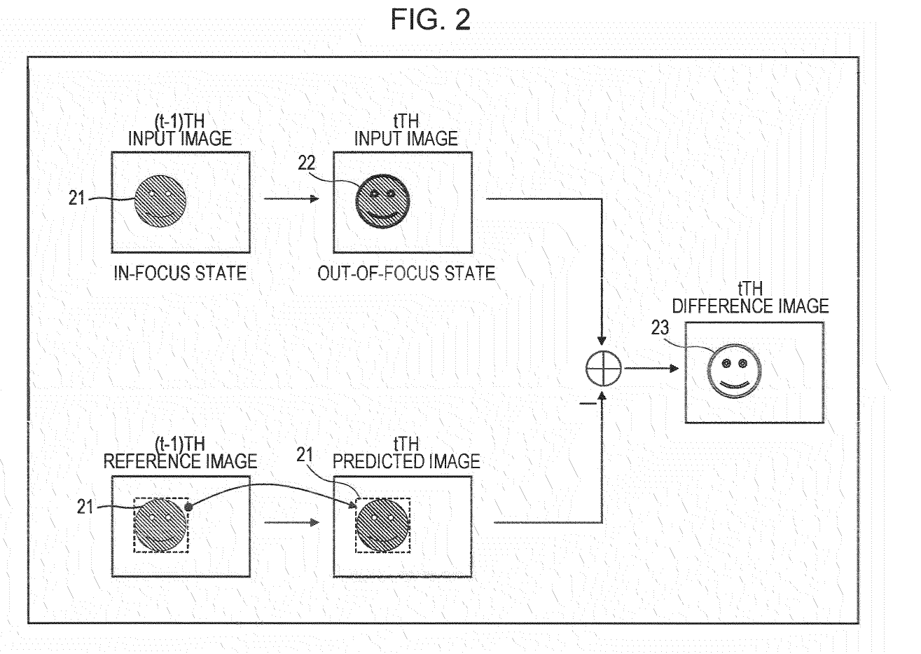

### DESCRIPTION OF EMBODIMENTS

### 1. Assumption of Invention

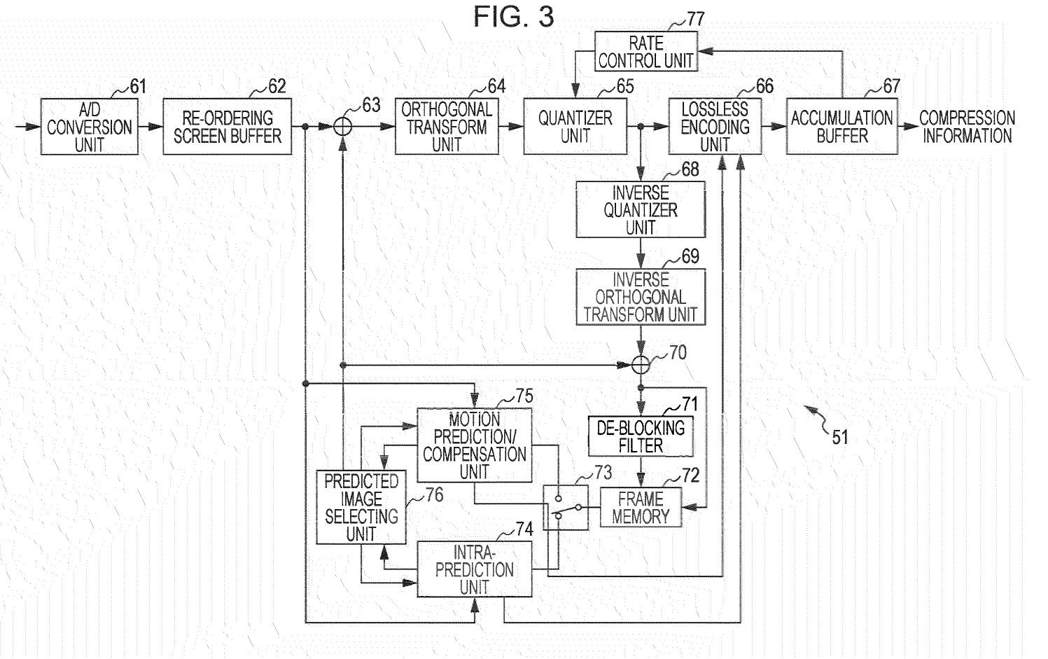

An image encoding apparatus and an image decoding apparatus according to the present invention are described first with reference to FIGS. 3 to 5.

FIG. 3 illustrates the configuration of an image encoding apparatus according to the present invention. An image encoding apparatus 51 includes an A/D conversion unit 61, a re-ordering screen buffer 62, a computing unit 63, an orthogonal transform unit 64, a quantizer unit 65, a lossless encoding unit 66, an accumulation buffer 67, an inverse quantizer unit 68, an inverse orthogonal transform unit 69, a computing unit 70, a de-blocking filter 71, a frame memory 72, a switch 73, an intra prediction unit 74, a motion prediction/compensation unit 75, a predicted image selecting unit 76, and a rate control unit 77. The image encoding apparatus 51 compression-encodes an image using, for example, the H.264/AVC standard.

The A/D conversion unit 61 A/D-converts an input image and outputs a converted image into the re-ordering screen buffer 62, which stores the converted image. Thereafter, the re-ordering screen buffer 62 re-orders, in accordance with the GOP (Group of Picture), the images of frames arranged in the order in which they are stored so that the images are arranged in the order in which the frames are to be encoded.

The computing unit 63 subtracts, from the image read from the re-ordering screen buffer 62, one of the following two predicted images selected by the predicted image selecting unit 76: an intra predicted image and a predicted image generated through inter prediction (hereinafter referred to as an “inter predicted image”). Thereafter, the computing unit 63 outputs the resultant difference to the orthogonal transform unit 64. The orthogonal transform unit 64 performs orthogonal transform, such as discrete cosine transform or Karhunen-Loeve transform, on the difference received from the computing unit 63 and outputs the transform coefficient. The quantizer unit 65 quantizes the transform coefficient output from the orthogonal transform unit 64.

The quantized transform coefficient output from the quantizer unit 65 is input to the lossless encoding unit 66. Thereafter, a lossless encoding process, such variable-length coding (e.g., CAVLC (Context-Adaptive Variable Length Coding)) or an arithmetic coding (e.g., CABAC (Context-Adaptive Binary Arithmetic Coding)), is performed on the quantized transform coefficient. Thus, the transform coefficient is compressed. The resultant compressed image is accumulated in the accumulation buffer 67 and, subsequently, is output.

In addition, the quantized transform coefficient output from the quantizer unit 65 is also input to the inverse quantizer unit 68 and is inverse-quantized. Thereafter, the transform coefficient is further subjected to inverse orthogonal transformation in the inverse orthogonal transducer unit 69. The result of the inverse orthogonal transformation is added to an inter predicted image or an intra predicted image by the computing unit 70 supplied from the predicted image selecting unit 76. In this way, a locally decoded image is generated. The de-blocking filter 71 removes block distortion of the locally decoded image and supplies the locally decoded image to the frame memory 72. Thus, the locally decoded image is accumulated. In addition, the image before the de-blocking filter process is performed by the de-blocking filter 71 is also supplied to the frame memory 72 and is accumulated.

The switch 73 outputs the image accumulated in the frame memory 72 to the motion prediction/compensation unit 75 or the intra prediction unit 74.

In the image encoding apparatus 51, for example, an I picture, a B picture, and a P picture received from the re-ordering screen buffer 62 are supplied to the intra prediction unit 74 as images to be subjected to intra prediction. In addition, a B picture and a P picture read from the re-ordering screen buffer 62 are supplied to the motion prediction/compensation unit 75 as images to be subjected to inter prediction.

The intra prediction unit 74 performs an intra prediction process in all of candidate intra prediction modes using the image to be subjected to intra prediction and read from the re-ordering screen buffer 62 and an image supplied from the frame memory 72 via the switch 73. Thus, the intra prediction unit 74 generates an intra predicted image.

Note that in the H.264/AVC coding standard, as an intra prediction mode for a luminance signal, a 4×4 pixel block based prediction mode, an 8×8 pixel block based prediction mode, and a 16×16 pixel block based prediction mode are defined. That is, macroblock based prediction modes are defined. In addition, an intra prediction mode for a color difference signal can be defined independently from the intra prediction mode for a luminance signal. The intra prediction mode for a color difference signal is defined on the basis of a macroblock.

In addition, the intra prediction unit 74 computes a cost function value for each of the all candidate intra prediction modes.

The cost function values is computed using one of the techniques of a High Complexity mode and a Low Complexity mode as defined in the JM (Joint Model), which is H.264/AVC reference software.

More specifically, when the High Complexity mode is employed as a technique for computing a cost function value, the processes up to the encoding process are temporarily performed for all of the candidate prediction modes. Thus, a cost function value defined by the following equation (1) is computed for each of the intra prediction modes.

Cost(Mode)=D+λ·R (1)

D denotes the difference (distortion) between the original image and the decoded image, R denotes an amount of generated code including up to the orthogonal transform coefficient, and λ denotes the Lagrange multiplier in the form of a function of a quantization parameter QP.

In contrast, when the Low Complexity mode is employed as a technique for computing a cost function value, generation of an intra predicted image and computation of header bits (e.g., information indicating the intra prediction mode) are performed. Thus, the cost function expressed in the following equation (2) is computed for each of the intra prediction modes.

Cost(Mode)=D+QPtoQuant(QP)·Header_Bit (2)

D denotes the difference (distortion) between the original image and the decoded image, Header_Bit denotes a header bit for the prediction mode, and QPtoQuant denotes a function provided in the form of a function of a quantization parameter QP.

In the Low Complexity mode, only an intra predicted image can be generated for each of the intra prediction mode. An encoding process needs not be performed. Accordingly, the amount of computation can be reduced.

The intra prediction unit 74 selects, as an optimal intra prediction mode, the intra prediction mode that provides a minimum value from among the cost function values computed in this manner. The intra prediction unit 74 supplies the intra predicted image generated in the optimal intra prediction mode and the cost function value thereof to the predicted image selecting unit 76. If the intra predicted image generated in the optimal intra prediction mode is selected by the predicted image selecting unit 76, the intra prediction unit 74 supplies information indicating the optimal intra prediction mode to the lossless encoding unit 66. The lossless encoding unit 66 lossless encodes the information and uses the information as part of the header information.

The motion prediction/compensation unit 75 performs a motion prediction/compensation process for each of the candidate inter prediction modes. More specifically, the motion prediction/compensation unit 75 detects a motion vector in each of the candidate inter prediction modes on the basis of the image to be inter predicted read from the re-ordering screen buffer 62 and the image serving as a reference image supplied from the frame memory 72 via the switch 73. Thereafter, the motion prediction/compensation unit 75 performs the motion compensation process on the reference image on the basis of the motion vector and generates a motion compensated image.

Note that in the MPEG2 standard, the block size is fixed (16×16 pixel basis for an inter-frame motion prediction/compensation process and 16×8 pixel basis for each field in an inter-field prediction/compensation process), and a motion prediction/compensation process is performed. However, in the H.264/AVC standard, the block size is variable, and a motion prediction/compensation process is performed.

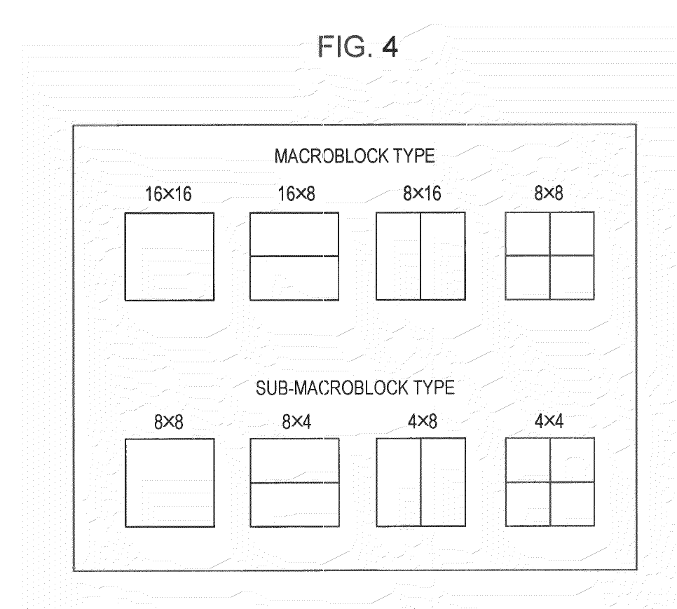

More specifically, as shown in FIG. 4, in the H.264/AVC standard, a macroblock including 16×16 pixels is separated into one of 16×16 pixel partitions, 16×8 pixel partitions, 8×16 pixel partitions, and 8×8 pixel partitions. Each of the partitions can have independent motion vector information. In addition, as shown in FIG. 4, an 8×8 pixel partition can be separated into one of 8×8 pixel sub-partitions, 8×4 pixel sub-partitions, 4×8 pixel sub-partitions, and 4×4 pixel sub-partitions. Each of the sub-partitions can have independent motion vector information.

Accordingly, the inter prediction mode includes eight types of mode for detecting a motion vector on one of a 16×16 pixel basis, a 16×8 pixel basis, a 8×16 pixel basis, a 8×8 pixel basis, a 8×4 pixel basis, a 4×8 pixel basis, and a 4×4 pixel basis.

In addition, the motion prediction/compensation unit 75 computes a cost function value for each of the all candidate inter prediction modes using a technique that is the same as the technique employed by the intra prediction unit 74. The motion prediction/compensation unit 75 selects, as an optimal inter prediction mode, the prediction mode that minimizes the cost function value from among the computed cost function values.

Thereafter, the motion prediction/compensation unit 75 supplies the motion-compensated image generated in the optimal inter prediction mode to the predicted image selecting unit 76 as the inter predicted image. In addition, the motion prediction/compensation unit 75 supplies the cost function value of the optimal inter prediction mode to the predicted image selecting unit 76. When the inter predicted image generated by the predicted image selecting unit 76 in the optimal inter prediction mode is selected, the motion prediction/compensation unit 75 outputs, to the lossless encoding unit 66, information regarding the optimal inter prediction mode and information associated with the optimal inter prediction mode (e.g., the motion vector information and the reference frame information). The lossless encoding unit 66 performs a lossless encoding process on the information received from the motion prediction/compensation unit 75 and inserts the information into the header portion of the compressed image.

The predicted image selecting unit 76 selects the optimal prediction mode from the optimal intra prediction mode and an optimal inter prediction mode on the basis of the cost function values output from the intra prediction unit 74 and the motion prediction/compensation unit 75. Thereafter, the predicted image selecting unit 76 selects one of the intra predicted image and the inter predicted image serving as a predicted image in the selected optimal prediction mode and supplies the selected predicted image to the computing units 63 and 70. At that time, the predicted image selecting unit 76 supplies information indicating that the intra predicted image has been selected to the intra prediction unit 74 or supplies information indicating that the inter predicted image has been selected to the motion prediction/compensation unit 75.

The rate control unit 77 controls the rate of the quantization operation performed by the quantizer unit 65 on the basis of the compressed images accumulated in the accumulation buffer 67 as compressed information including a header portion so that overflow and underflow of the accumulation buffer 67 does not occur.

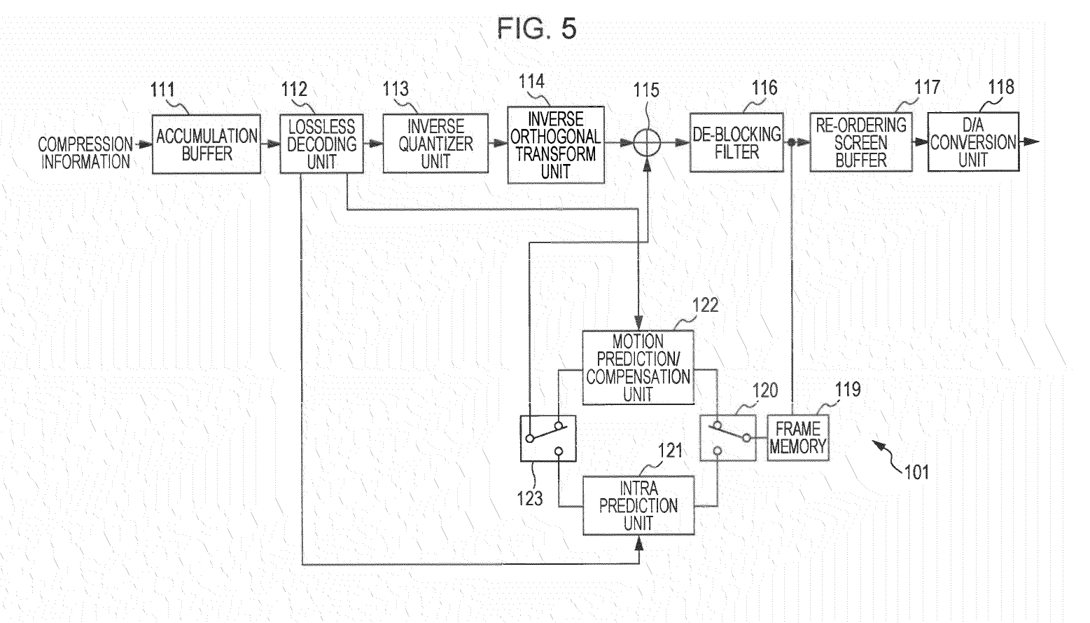

The compression information encoded by the image encoding apparatus 51 having the above-described configuration is transmitted via a predetermined transmission path and is decoded by the image decoding apparatus. FIG. 5 illustrates the configuration of such an image decoding apparatus.

An image decoding apparatus 101 includes an accumulation buffer 111, a lossless decoding unit 112, an inverse quantizer unit 113, an inverse orthogonal transform unit 114, a computing unit 115, a de-blocking filter 116, a re-ordering screen buffer 117, a D/A conversion unit 118, a frame memory 119, a switch 120, an intra prediction unit 121, a motion prediction/compensation unit 122, and a switch 123.

The accumulation buffer 111 accumulates transmitted compressed images. The lossless decoding unit 112 lossless decodes (variable-length decodes or arithmetic decodes) compressed information encoded by the lossless encoding unit 66 shown in FIG. 3 and supplied from the accumulation buffer 111 using a method corresponding to the lossless encoding method employed by the lossless encoding unit 66. Thereafter, the lossless decoding unit 112 extracts, from information obtained through the lossless decoding, the image, the information indicating an optimal inter prediction mode or an optimal intra prediction mode, the motion vector information, and the reference frame information.

The inverse quantizer unit 113 inverse quantizes an image decoded by the lossless decoding unit 112 using a method corresponding to the quantizing method employed by the quantizer unit 65 shown in FIG. 3. Thereafter, the inverse quantizer unit 113 supplies the resultant transform coefficient to the inverse orthogonal transform unit 114. The inverse orthogonal transform unit 114 performs fourth-order inverse orthogonal transform on the transform coefficient received from the inverse quantizer unit 113 using a method corresponding to the orthogonal transform method employed by the orthogonal transform unit 64 shown in FIG. 3.

The inverse orthogonal transformed output is added to the intra predicted image or the inter predicted image supplied from the switch 123 and is decoded by the computing unit 115. The de-blocking filter 116 removes block distortion of the decoded image and supplies the resultant image to the frame memory 119. Thus, the image is accumulated. At the same time, the image is output to the re-ordering screen buffer 117.

The re-ordering screen buffer 117 re-orders images. That is, the order of frames that has been changed by the re-ordering screen buffer 62 shown in FIG. 3 for encoding is changed back to the original display order. The D/A conversion unit 118 D/A-converts an image supplied from the re-ordering screen buffer 117 and outputs the image to a display (not shown), which displays the image.

The switch 120 reads, from the frame memory 119, an image serving as a reference image in the inter prediction when the image is encoded. The switch 120 outputs the image to the motion prediction/compensation unit 122. In addition, the switch 120 reads an image used for intra prediction from the frame memory 119 and supplies the readout image to the intra prediction unit 121.

The intra prediction unit 121 receives, from the lossless decoding unit 112, information indicating an optimal intra prediction mode obtained by decoding the header information. When the information indicating an optimal intra prediction mode is supplied, the intra prediction unit 121 performs an intra prediction process in the intra prediction mode indicated by the information using the image received from the frame memory 119. Thus, the intra prediction unit 121 generates a predicted image. The intra prediction unit 121 outputs the generated predicted image to the switch 123.

The motion prediction/compensation unit 122 receives information obtained by lossless decoding the header information (e.g., the information indicating the optimal inter prediction mode, the motion vector information, and the reference image information) from the lossless decoding unit 112. Upon receiving the information indicating an optimal inter prediction mode, the motion prediction/compensation unit 122 performs a motion compensation process on the reference image received from the frame memory 119 in the optimal inter prediction mode indicated by the information using the motion vector information and the reference frame information supplied together with the information indicating an optimal inter prediction mode. Thus, the motion prediction/compensation unit 122 generates a motion-compensated image. Thereafter, the motion prediction/compensation unit 122 outputs the motion-compensated image to the switch 123 as the inter predicted image.

The switch 123 supplies, to the computing unit 115, the inter predicted image supplied from the motion prediction/compensation unit 122 or the intra predicted image supplied from the intra prediction unit 121.

### 2. First Embodiment

### Example of Configuration of Image Encoding Apparatus

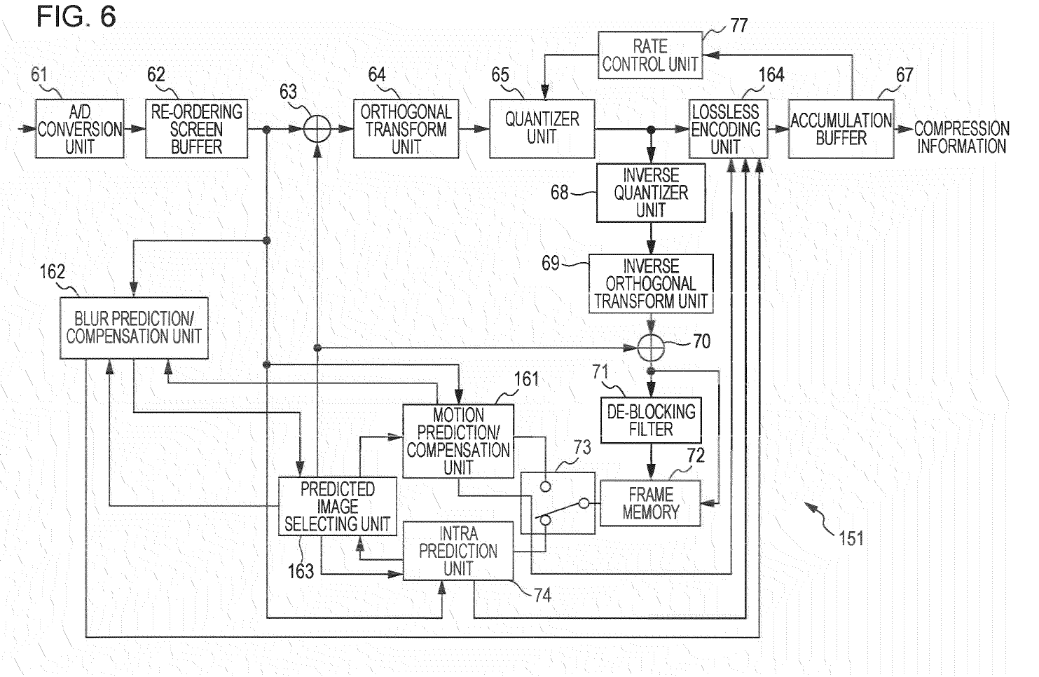

Next, FIG. 6 illustrates an example of the configuration of an image encoding apparatus according to a first embodiment of the present invention.

The same numbering will be used in referring to the configuration in FIG. 6 as is utilized above in describing the configuration in FIG. 3. The same descriptions are not repeated.

The configuration of an image encoding apparatus 151 shown in FIG. 6 mainly differs from the configuration shown in FIG. 3 in that the image encoding apparatus 151 includes a motion prediction/compensation unit 161, a predicted image selecting unit 163, and a lossless encoding unit 164 in place of the motion prediction/compensation unit 75, the predicted image selecting unit 76, and the lossless encoding unit 66 and further includes a blur prediction/compensation unit 162.

More specifically, like the motion prediction/compensation unit 75 shown in FIG. 3, the motion prediction/compensation unit 161 of the image encoding apparatus 151 shown in FIG. 6 performs a motion prediction/compensation process in all of the candidate inter prediction modes. In addition, like the motion prediction/compensation unit 75, the motion prediction/compensation unit 161 computes the cost function values for all of the candidate inter prediction modes. Furthermore, like the motion prediction/compensation unit 75, the motion prediction/compensation unit 161 selects, as an optimal inter prediction mode, the inter prediction mode that provides a minimum value from among the computed cost function values.

The motion prediction/compensation unit 161 supplies a motion-compensated image generated in the optimal inter prediction mode to the blur prediction/compensation unit 162. In addition, like the motion prediction/compensation unit 75, if the inter predicted image generated in the optimal inter prediction mode is selected by the predicted image selecting unit 163, the motion prediction/compensation unit 161 outputs, to the lossless encoding unit 164, information indicating the optimal inter prediction mode and information associated with the optimal inter prediction mode (e.g., the motion vector information and the reference frame information).

The blur prediction/compensation unit 162 detects a variation in blur on the basis of the motion-compensated image supplied from the motion prediction/compensation unit 161 and the image that is used for a motion prediction/compensation process after the motion compensation and that is to be inter predicted and that is output from the re-ordering screen buffer 62. Thereafter, the blur prediction/compensation unit 162 performs a blur compensation process in order to generate or remove blur in the motion-compensated image on the basis of blur information indicating the detected variation in blur. Thus, the blur prediction/compensation unit 162 generates a motion-compensated and blur-compensated image.

In addition, the blur prediction/compensation unit 162 computes the cost function value of the motion-compensated and blur-compensated image using a technique that is the same as the technique employed by the motion prediction/compensation unit 161. Thereafter, the blur prediction/compensation unit 162 supplies the generated motion-compensated and blur-compensated image to the predicted image selecting unit 163 as the inter predicted image. In addition, the blur prediction/compensation unit 162 supplies the cost function value to the predicted image selecting unit 163.

Furthermore, if the inter predicted image generated in the optimal inter prediction mode is selected by the predicted image selecting unit 163, the blur prediction/compensation unit 162 outputs the blur information to the lossless encoding unit 164. Note that the blur prediction/compensation unit 162 is described in more detail below.

The predicted image selecting unit 163 determines the optimal prediction mode from the optimal intra prediction mode and the optimal inter prediction mode using the cost function values output from the intra prediction unit 74 or the blur prediction/compensation unit 162. Thereafter, the predicted image selecting unit 163 selects the intra predicted image or the inter predicted image as a predicted image of the determined optimal prediction mode. Subsequently, the predicted image selecting unit 163 supplies the selected predicted image to the computing units 63 and 70.

At that time, the predicted image selecting unit 163 supplies selection information indicating that the intra predicted image is selected to the intra prediction unit 74 or supplies selection information indicating that the inter predicted image is selected to the motion prediction/compensation unit 161 and the blur prediction/compensation unit 162.

Like the lossless encoding unit 66, the lossless encoding unit 164 performs lossless encoding on the quantized transform coefficient supplied from the quantizer unit 65 and compresses the transform coefficient. Thus, the lossless encoding unit 164 generates a compressed image. In addition, the lossless encoding unit 164 performs lossless encoding on the information received from the intra prediction unit 74, the motion prediction/compensation unit 161, or the blur prediction/compensation unit 162 and inserts the information into the header portion of the compressed image. Thereafter, the compressed image including the header portion generated by the lossless encoding unit 164 is accumulated in the accumulation buffer 67 as compression information and is subsequently output.

As described above, the image encoding apparatus 151 performs not only motion compensation but blur compensation in the inter prediction. Accordingly, even when blur occurs or disappears between an image to be inter predicted and the reference image, the inter prediction can be more accurately performed. As a result, the quality of the inter predicted image (e.g., the PSNR of the inter predicted image with respect to an image to be inter predicted) can be increased.

### [Detailed Configuration Example of Blur Prediction/Compensation Unit 162]

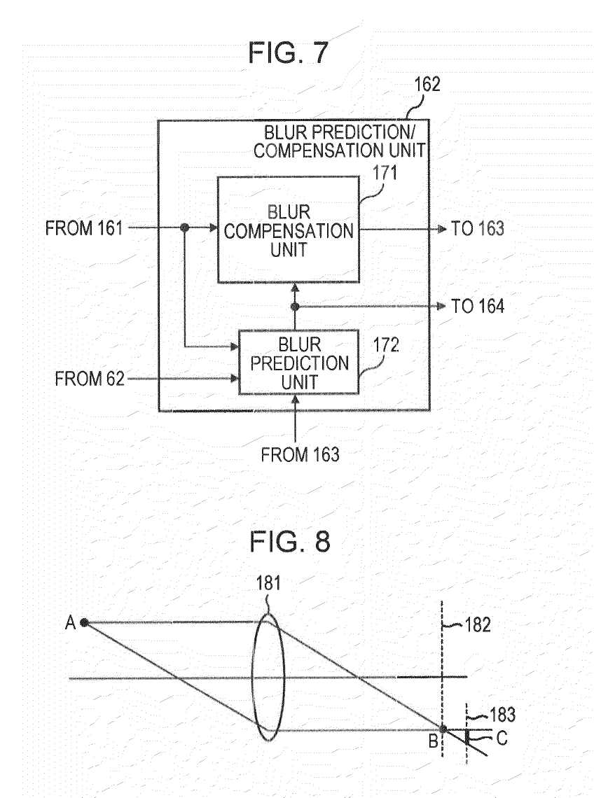

FIG. 7 illustrates a detailed configuration example of the blur prediction/compensation unit 162 shown in FIG. 6.

As shown in FIG. 7, the blur prediction/compensation unit 162 includes a blur compensation unit 171 and a blur prediction unit 172.

The blur compensation unit 171 performs the blur compensation process on the motion-compensated image supplied from the motion prediction/compensation unit 161 on the basis of the blur information supplied from the blur prediction unit 172. In addition, the blur compensation unit 171 computes the cost function value of the motion-compensated and blur compensated image obtained through the blur compensation process using a technique that is similar to the technique employed by the motion prediction/compensation unit 161. Thereafter, the blur compensation unit 171 supplies the motion-compensated and blur compensated image to the predicted image selecting unit 163 as the inter predicted image. In addition, the blur compensation unit 171 supplies the cost function value to the predicted image selecting unit 163.

The blur prediction unit 172 predicts a variation in blur on the basis of the motion-compensated image supplied from the motion prediction/compensation unit 161 and an image to be inter predicted supplied from the re-ordering screen buffer 62 and generates blur information indicating the variation in blur. Thereafter, the blur prediction unit 172 supplies the generated blur information to the blur compensation unit 171. In addition, upon receiving the selection information indicating that the inter predicted image is selected from the predicted image selecting unit 163, the blur prediction unit 172 supplies the blur information to the lossless encoding unit 164.

### [Description of Blur Information]

The blur information is described next with reference to FIGS. 8 to 11.

The mechanism through which blur occurs when an out-of-focus state occurs during an image capturing time (hereinafter referred to as “focus blur” or “defocus”) is described first with reference to FIG. 8.

As shown in FIG. 8, when a spot-shaped light beam is generated at a point A, the light beam temporarily diffuses and, thereafter, is focused by a lens 181 of an image capturing unit. Thus, an image is formed at point B in an image forming plane 182. In this way, the light beam comes to have a spot-shaped form again. However, the light beam has a spreading area at a point C in a plane 183 spaced apart the image forming plane 182. That is, the light beam having the point A has a width at point C in the plane 183 and, therefore, the position thereof becomes vague. That is, blur occurs in the plane 183.

When the light beam is in focus, the light beam output from the point A is received by a single photosensor, since an imaging device of the image capturing unit including a plurality of photosensors is located in the image forming plane 182. Thus, an image in which the position from which a light beam corresponding to the point A is generated is clear can be obtained. In contrast, if an out-of-focus state occurs, the light beam output from the point A is a plurality of photosensers, since the imaging device is located in a plane (e.g., the plane 183) spaced apart from the image forming plane 182. Therefore, the light beam output from the point A is received by the plurality of photosensers, and an image in which the position corresponding to the point A is unclear, that is, an image having blur is obtained.

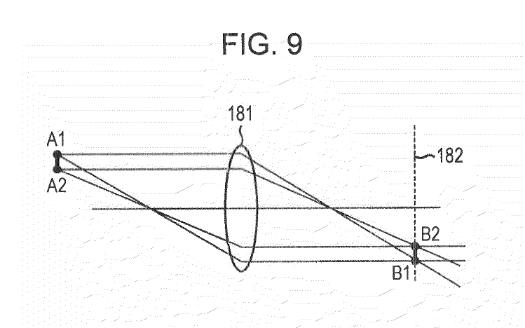

The mechanism through which blur occurs due to movement of a subject or the image capturing unit at an image capturing time (hereinafter referred to as “motion blur”) is described next with reference to FIG. 9.

As shown in FIG. 9, when a spot-shaped light beam is generated at a point A1, the light beam becomes a spot-shaped light beam at a point B1 in the image forming plane 182, as illustrated in FIG. 8. Thereafter, if the spot-shaped light beam is relatively moved from a point A1 to a point A2 due to movement of a subject or the image capturing unit, the light beam in the image forming plane 182 moves from a point B1 to a point B2.

Accordingly, when a light beam is in focus and an imaging device of the image capturing unit including a plurality of photosensors is located on the image forming plane 182 and if a spot-shaped light beam is relatively moved from the point A1 to the point A2 due to movement of a subject or the image capturing unit, the light beam is received by a plurality of photodetectors. As a result, an image in which the position from which the light beam is generated is unclear, that is, an image having blur can be obtained.

The focus blur or the motion blur occurring in the above-described manner can be defined as the output obtained when a spot-shaped light beam is input, that is, the impulse response. In FIG. 8, the input is, for example, a spot-shaped light beam generated at the point A. The impulse response is a light beam output onto the imaging device (e.g., the points B and C). In addition, in FIG. 9, the input is, for example, a spot-shaped light beam generated at the point A1. The impulse response is a light beam output onto the imaging device (e.g., the range from the point B1 to the point B2).

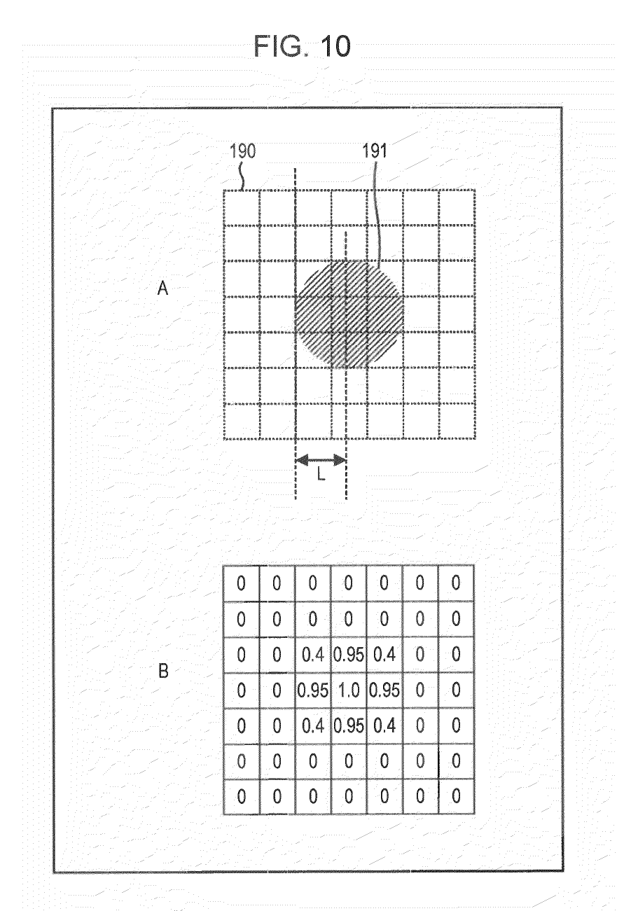

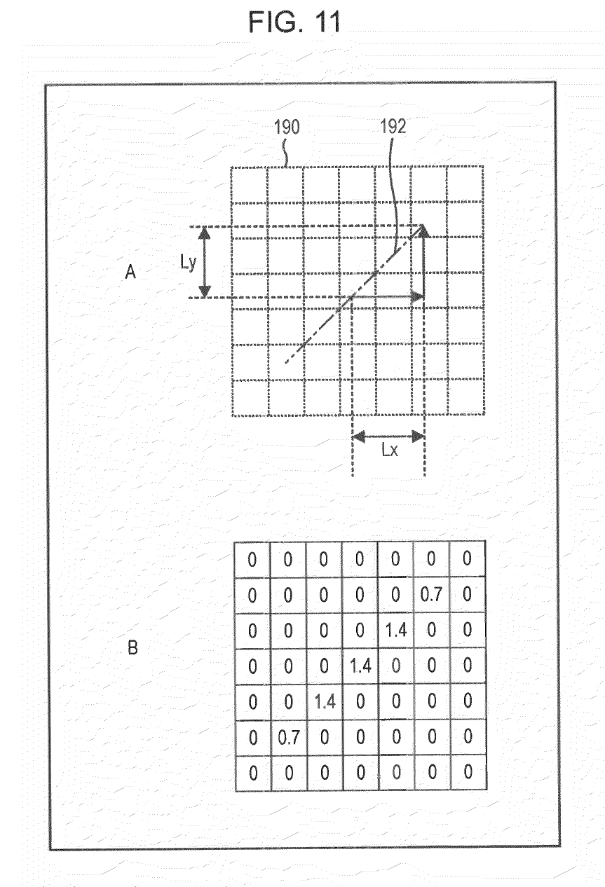

Accordingly, for example, as indicated by “A” shown in FIG. 10, information indicating a radius L of a light beam 191 output onto an imaging device 190 serving as the impulse response is used as blur information regarding focus blur. Note that squares arranged on the imaging device 190 in a lattice in “A” of FIG. 10 represents photosensors each corresponding to a pixel. This also applies to “A” of FIG. 11 described below.

In addition, in the case illustrated in “A” of FIG. 10, focus blur occurs. Accordingly, the light beam 191 has a circular diffuse shape having a diameter of 2L. However, if focus blur does not occur, the light beam 191 has a spot shape.

As described above, if information indicating a radius of L is used as the blur information regarding the focus blur, the blur prediction unit 172 applies FIR filters having filter coefficients corresponding to possible values of the predetermined radius L to the motion-compensated image supplied from the motion prediction/compensation unit 161.

For example, as FIR filters corresponding to the radius L in “A” of FIG. 10, the blur prediction unit 172 applies FIR filters having filter coefficients corresponding to the values in “B” of FIG. 10 to the motion-compensated image. Note that each of the squares arranged in a lattice shown in “B” of FIG. 10 corresponds to a pixel. The number written in a square corresponds to a filter coefficient. More specifically, the number written in a square represents the ratio of a light receiving area of the photosensor corresponding to a pixel to a light receivable area of the photosensor corresponding to the pixel. Since the amplification degree of the DC component of the image is set to 1, the filter coefficient is set so that the sum of the ratios is 1. That is, in “B” of FIG. 10, since the sum of the ratios is 6.4 (=0.4×4+0.95×4+1.0), the filter coefficients corresponding to the pixels having the ratios 0.4, 0.95, and 1.0 are set to 0.4/6.4, 0.95/6.4, and 1.0/6.4, respectively.

The blur prediction unit 172 computes a difference between each of images for the FIR filters obtained after the filters are applied to the motion-compensated image and the image to be inter predicted supplied from the re-ordering screen buffer 62. Thereafter, the blur prediction unit 172 selects, as blur information, information indicating the radius L corresponding to the FIR filter having the minimized difference.

In addition, for example, as shown in “A” of FIG. 11, the following information is selected as motion blur information: information indicating a length Lx in the horizontal direction and a length Ly in the vertical direction from the center of a light beam 192 output onto the imaging device 190 as an impulse response.

Note that in the example shown in “A” of FIG. 11, motion blur occurs. Accordingly, the light beam 192 is 2Lx in length in the horizontal direction and 2Ly in length in the vertical direction, and the size of the light beam 192 increases in a diagonal line shape. However, if motion blur does not occur, the light beam 192 has a spot shape.

As described above, when the blur information for motion blur is information indicating the lengths Lx and Ly, the filter applied in the blur prediction unit 172 is an FIR filter having a filter coefficient corresponding to a combination of a possible value of the length Lx and a possible value of the length Ly.

For example, an FIR filter corresponding to the lengths Lx and Ly shown in “A” of FIG. 11 has filter coefficients corresponding to the values shown in “B” of FIG. 11. Note that in “B” of FIG. 11, each of the squares arranged in a lattice corresponds to a pixel. The numbers written in the squares indicate values corresponding to the filter coefficients. More specifically, in “B” of FIG. 11, the numbers written in the squares each corresponding to a pixel indicates the length of the light beam 192 in the pixel. In the example shown in “B” of FIG. 11, the sides of the pixel are 1. Accordingly, the length of the diagonal line of the pixel is √2 (≈1.4). Therefore, the numbers written in the squares corresponding to the pixels are 1.4 or 0.7.

Like focus blur, in the case of motion blur, the amplification degree of the DC component of an image is set to 1. Accordingly, the numbers in the squares having the sum of 1 are used as the filter coefficients. That is, in “B” of FIG. 11, the sum of the numbers is 5.6 (=0.7×2+1.4×3). Thus, the filter coefficients corresponding to the squares having the numbers 0.7 and 1.4 are set to 0.7/5.6 and 1.4/5.6, respectively.

It should be noted that a technique for setting the filter coefficient is not limited to those illustrated in FIGS. 10 and 11. Any technique in which the filter coefficients are uniquely set in accordance with the blur information can be employed.

In addition, if the image encoding apparatus 151 and an image decoding apparatus corresponding to the image encoding apparatus 151 prestore the same set of the filter coefficients, the image encoding apparatus 151 may transmit the identifier of the set of filter coefficients to the image decoding apparatus instead of the blur information. The amount of data of the identifier is smaller than that of the blur information. Accordingly, if the image encoding apparatus 151 transmits the filter coefficients instead of the blur information, an increase in the amount of code can be minimized.

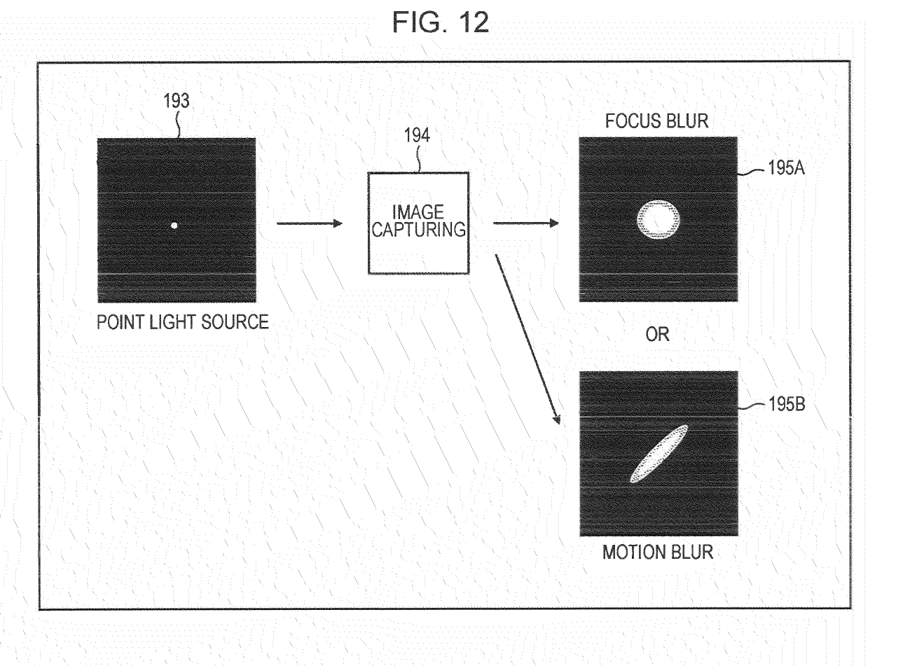

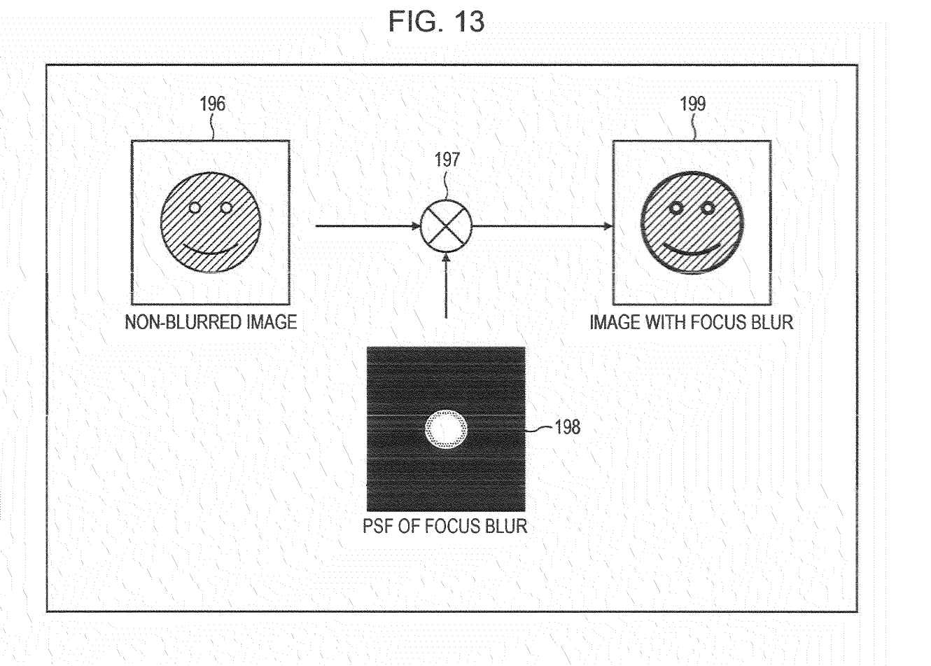

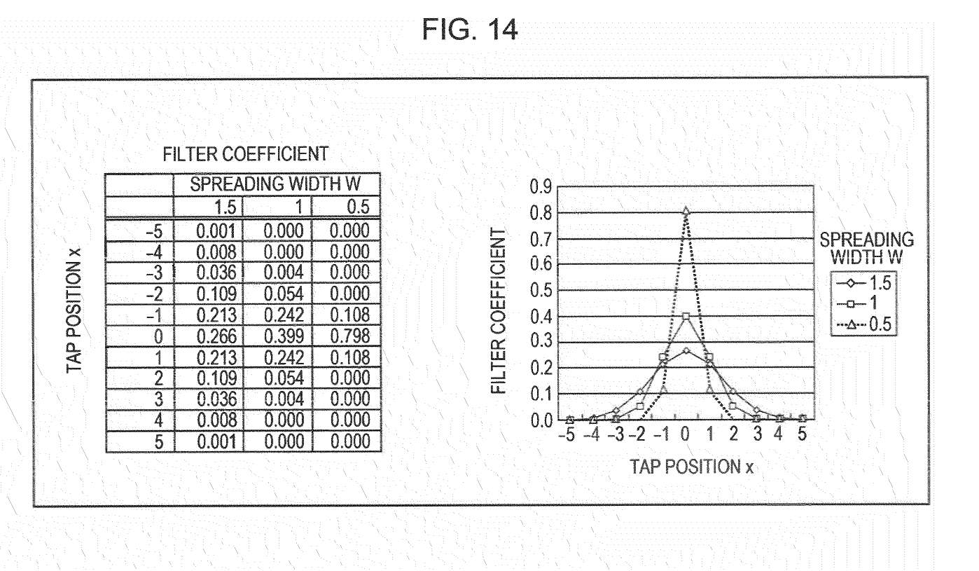

Note that while the blur information regarding focus blur has been described separately from the blur information regarding motion blur, a point spread function (described below with reference to FIGS. 12 and 13) can be employed for both types of blur information. Hereinafter, the term “point spread function” is also referred to as a “PSF”.

As shown in FIG. 12, when a point light source 193 passes through image capturing 194, focus blur 195A or motion blur 195B caused by shaking of a camera or the movement of the subject occurs.

As shown in FIG. 13, if a convolution operation 197 corresponding to an FIR filter is performed on a non-blurred image 196 using a PSF 198 of focus blur, an image 199 with focus blur can be obtained.

That is, as illustrated in FIGS. 8 and 9, the focus blur 195A and the motion blur 195B shown in FIG. 12 are in the form of images obtained by observing the point light source 193 through a camera and correspond to the impulse response of a system of the image capturing 194. In contrast, the PSF 198 shown in FIG. 13 serves as a model for representing focus blur or motion blur. That is, by computing the filter coefficients of an FIR filter using the PSF 198 and performing a convolution operation 197 corresponding to the FIR filter having the computed filter coefficients on the non-blurred image 196, the image 199 with focus blur can be obtained.

Note that while the example shown in FIG. 13 has been described with reference to focus blur, an image with motion blur can be obtained in a similar manner.

The PSF is described next. The PSF represents an image obtained by observing how a point light source changes through some system. If the system causes blur, the PSF serves as a function having the following three characteristics. That is, firstly, as indicated by equation (3), the PSF is 1 when the PSF is integrated. Secondly, the blur caused by a lens (focus blur) can be approximated to a two-dimensional normal distribution. Thirdly, in the case of motion blur, the PSF serves as a function corresponding to the trajectory of the motion.

$$\begin{matrix}[ Math . 1 ] & \\ {\int }_{- ∞}^{+ ∞} {\int }_{- ∞}^{+ ∞} h ( x , y ) d x d y = 1 & ( 3 )\end{matrix}$$

Accordingly, in encoding, the second characteristic is employed. In order to express blur using minimized information, the spreading width of a two-dimensional normal distribution is used as the blur information transmitted from the encoding side to the decoding side. That is, in this way, the amount of focus blur can be expressed using a single variable.

First, for simplicity, one-dimensional normal distribution can be expressed by the following equation (4):

$$\begin{matrix}[ Math . 2 ] & \\ f ( x ) = \frac{1}{\sqrt{2 π} W} exp ( - {x}^{2} / ( 2 \times {W}^{2} ) ) & ( 4 )\end{matrix}$$

where W denotes the spreading width, and x denotes the position of the tap of an FIR filter. Accordingly, by using equation (4), the filter coefficients can be computed.

FIG. 14 illustrates the filter coefficients computed using the normal distribution equation (equation (4)). A graph illustrating the filter coefficients is shown in the left section of FIG. 14.

In the case of a spreading width W=1.5, the filter coefficient is 0.001 at a tap position x=−5, 5. In addition, the filter coefficient is 0.008 at a tap position x=−4, 4, and the filter coefficient is 0.036 at a tap position x=−3, 3. Furthermore, the filter coefficient is 0.109 at a tap position x=−2, 2, the filter coefficient is 0.213 at a tap position x=−1, 1, and the filter coefficient is 0.266 at a tap position x=0.

In the case of the spreading width W=1, the filter coefficient is 0.000 at a tap position x=−5, 5. In addition, the filter coefficient is 0.000 at a tap position x=−4, 4, and the filter coefficient is 0.004 at a tap position x=−3, 3. Furthermore, the filter coefficient is 0.054 at a tap position x=−2, 2, the filter coefficient is 0.242 at a tap position x=−1, 1, and the filter coefficient is 0.399 at a tap position x=0.

In the case of the spreading width W=0.5, the filter coefficient is 0.000 at a tap position x=−5, 5. In addition, the filter coefficient is 0.000 at a tap position x=−4, 4, and the filter coefficient is 0.000 at a tap position x=−3, 3. Furthermore, the filter coefficient is 0.000 at a tap position x=−2, 2, the filter coefficient is 0.108 at a tap position x=−1, 1, and the filter coefficient is 0.798 at a tap position x=0.

As described above, the filter coefficient is determined using the normal distribution equation (equation (4)) in accordance with the spreading width W.

Note that in a similar manner, the filter coefficients can be computed from the two-dimensional normal distribution indicated by equation (5).

$$\begin{matrix}[ Math . 3 ] & \\ f ( x , y ) = \frac{1}{\sqrt{2 π} W} exp ( - ( {x}^{2} + {y}^{2} ) / ( 2 \times {W}^{2} ) ) & ( 5 )\end{matrix}$$

where W also denotes the spreading width, and x and y denote the position of the tap of an FIR filter.

As described above, the information indicating the spreading width W can be also used as the blur information regarding focus blur. In such a case, an FIR filter applied in the blur prediction unit 172 is an FIR filter having a filter coefficient corresponding to a combination of possible values of the spreading width W (i.e., the values shown in FIG. 14).

### [Description of Encoding Process]

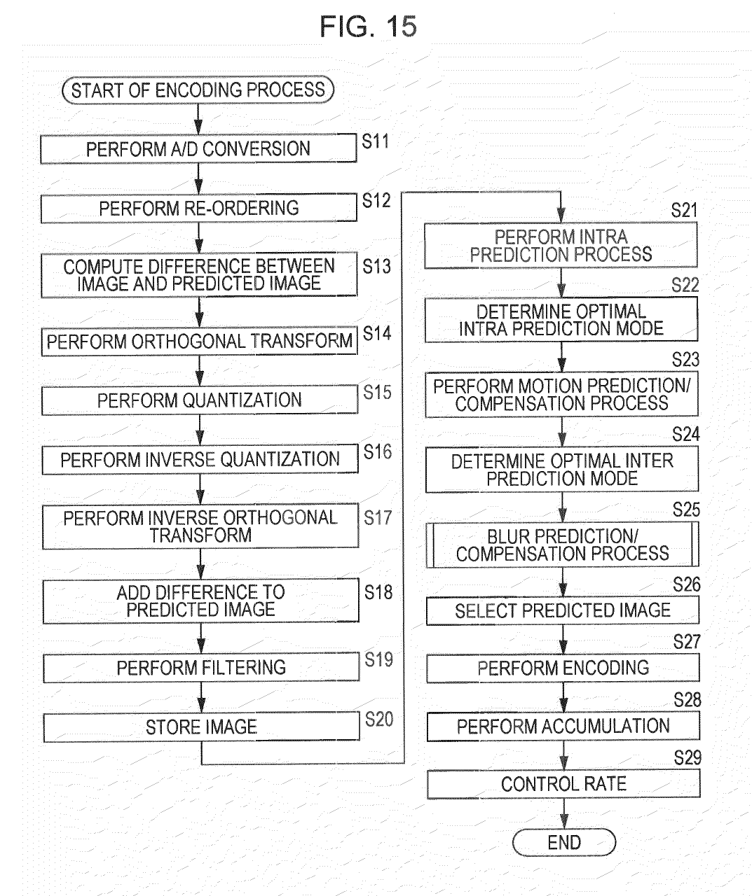

The encoding process performed by the image encoding apparatus 151 shown in FIG. 6 is described next with reference to a flowchart shown in FIG. 15.

In step S11, the A/D conversion unit 61 A/D-converts an input image. In step S12, the re-ordering screen buffer 62 stores the image supplied from the A/D conversion unit 61 and converts the order in which pictures are displayed into the order in which the pictures are to be encoded.

In step S13, the computing unit 63 computes the difference between the image re-ordered in step S12 and the intra predicted image or the inter predicted image received from the predicted image selecting unit 163.

The data size of the difference data is smaller than that of the original image data. Accordingly, the data size can be reduced, as compared with the case in which the image is directly encoded.

In step S14, the orthogonal transform unit 64 performs orthogonal transform on the difference supplied from the computing unit 63. More specifically, orthogonal transform, such as discrete cosine transform or Karhunen-Loeve transform, is performed, and a transform coefficient is output. In step S15, the quantizer unit 65 quantizes the transform coefficient. As described in more detail below with reference to a process performed in step S29, the rate is controlled in this quantization process.

The difference quantized in the above-described manner is locally decoded as follows. That is, in step S16, the inverse quantizer unit 68 inverse quantizes the transform coefficient quantized by the quantizer unit 65 using a characteristic that is the reverse of the characteristic of the quantizer unit 65. In step S17, the inverse orthogonal transform unit 69 performs inverse orthogonal transform on the transform coefficient inverse quantized by the inverse quantizer unit 68 using the characteristic corresponding to the characteristic of the orthogonal transform unit 64.

In step S18, the computing unit 70 adds the inter predicted image or the intra predicted image input via the predicted image selecting unit 163 to the locally decoded difference. Thus, the computing unit 70 generates a locally decoded image (an image corresponding to the input of the computing unit 63). In step S19, the de-blocking filter 71 performs filtering on the image output from the computing unit 70. In this way, block distortion is removed. In step S20, the frame memory 72 stores the filtered image. Note that the image that is not subjected to the filtering process performed by the de-blocking filter 71 is also supplied to the frame memory 72 and is stored in the frame memory 72.

In step S21, the intra prediction unit 74 performs an intra prediction process in all the candidate intra prediction modes on the basis of the image to be intra predicted read from the re-ordering screen buffer 62 and the image supplied from the frame memory 72 via the switch 73. Thus, the intra prediction unit 74 generates an intra predicted image. Thereafter, the intra prediction unit 74 computes the cost function values for all the candidate intra prediction modes.

In step S22, the intra prediction unit 74 selects, as an optimal intra prediction mode, the intra prediction mode that provides a minimum value from among the computed cost function values. Thereafter, the intra prediction unit 74 supplies the intra predicted image generated in the optimal intra prediction mode and the cost function value thereof to the predicted image selecting unit 163.

In step S23, the motion prediction/compensation unit 161 performs a motion prediction/compensation process in all the candidate inter prediction modes on the basis of the image to be inter predicted read from the re-ordering screen buffer 62 and the image serving as the reference image supplied from the frame memory 72 via the switch 73. Thereafter, the motion prediction/compensation unit 161 computes the cost function values for all of the candidate inter prediction modes.

In step S24, the motion prediction/compensation unit 161 selects, as an optimal inter prediction mode, the inter prediction mode that provides a minimum value from among the computed cost function values. Thereafter, the motion prediction/compensation unit 161 supplies a motion-compensated image generated in the optimal inter prediction mode to the blur prediction/compensation unit 162.

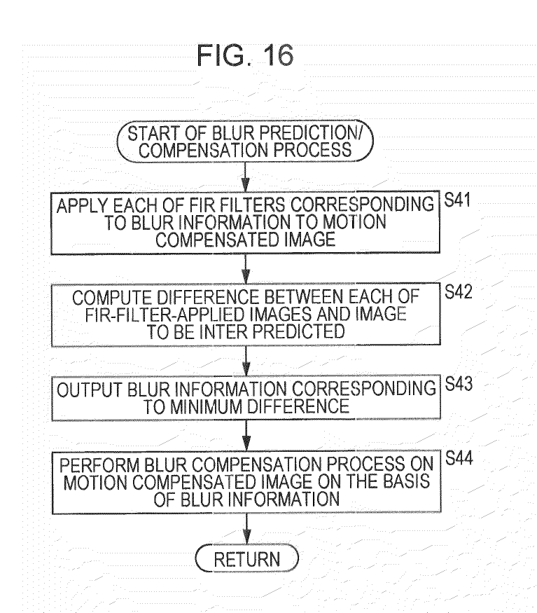

In step S25, the blur prediction/compensation unit 162 performs a blur prediction/compensation process on the basis of the motion-compensated image supplied from the motion prediction/compensation unit 161 and the image to be inter predicted that is used for the motion prediction/compensation process of the motion-compensated image and that is output from the re-ordering screen buffer 62. The blur prediction/compensation process is described in more detail below with reference to FIG. 16. The motion compensated and blur compensated image obtained through the blur prediction/compensation process and the cost function value of the image are supplied to the predicted image selecting unit 163 as an inter predicted image.

In step S26, the predicted image selecting unit 163 determines the optimal prediction mode from the optimal intra prediction mode and the optimal inter prediction mode using the cost function values output from the intra prediction unit 74 and the blur prediction/compensation unit 162. Thereafter, the predicted image selecting unit 163 selects the predicted image of the determined optimal prediction mode. In this way, the inter predicted image or the intra predicted image selected as a predicted image of the optimal prediction mode is supplied to the computing units 63 and 70 and is used for the computation performed in steps S13 and S18.

Note that at that time, the predicted image selecting unit 163 supplies selection information to the intra prediction unit 74 or both of the motion prediction/compensation unit 161 and the blur prediction/compensation unit 162. If the selection information indicating that the intra predicted image is selected is supplied, the intra prediction unit 74 supplies information indicating the optimal intra prediction mode to the lossless encoding unit 164.

Upon receiving the selection information indicating that the optimal inter prediction mode is selected, the motion prediction/compensation unit 161 outputs, for example, the information indicating the optimal inter prediction mode, the motion vector information, and the reference frame information to the lossless encoding unit 164. The blur prediction/compensation unit 162 outputs the blur information to the lossless encoding unit 164.

In step S27, the lossless encoding unit 164 encodes the quantized transform coefficient output from the quantizer unit 65 and generates a compressed image. At that time, information indicating the optimal intra prediction mode or the optimal inter prediction mode, the information associated with the optimal inter prediction mode (e.g., the motion vector information and reference frame information), and the blur information are also lossless-encoded and are inserted into the header portion of the compressed image.

In step S28, the accumulation buffer 67 accumulates the compressed image including the header portion generated by the lossless encoding unit 164 as compression information. The compression information accumulated in the accumulation buffer 67 is read out as needed and is transmitted to the image decoding apparatus via a transmission path.

In step S29, the rate control unit 77 controls the rate of the quantization operation performed by the quantizer unit 65 on the basis of the compression information accumulated in the accumulation buffer 67 so that overflow and underflow does not occur in the accumulation buffer 67.

### [Detailed Description of Blur Prediction/Compensation Process]

The blur prediction/compensation process performed in step S25 shown in FIG. 15 is described next with reference to a flowchart shown in FIG. 16.

In step S41, the blur prediction unit 172 (see FIG. 7) of the blur prediction/compensation unit 162 applies, to the motion-compensated image supplied from the motion prediction/compensation unit 161, the FIR filters having the filter coefficients corresponding to the possible values indicated by the blur information, such as the radius L, the lengths Lx and Ly, or the spreading width W.

In step S42, the blur prediction unit 172 computes a difference between each of the images to which the FIR filters have been applied and the image to be inter predicted supplied from the re-ordering screen buffer 62.

In step S43, the blur prediction unit 172 outputs the blur information corresponding to the minimum difference among the differences computed in step S42 to the blur compensation unit 171. More specifically, the blur prediction unit 172 outputs the blur information corresponding to the FIR filter used for generating the image having the minimum difference to the blur compensation unit 171. Note that if the selection information indicating that the inter predicted image has been selected is supplied from the predicted image selecting unit 163, the blur information is also output to the lossless encoding unit 164.

In step S44, the blur compensation unit 171 performs the blur compensation process on the motion-compensated image supplied from the motion prediction/compensation unit 161 on the basis of the blur information supplied from the blur prediction unit 172. More specifically, the blur compensation unit 171 applies the FIR filter having the filter coefficient corresponding to the blur information to the motion-compensated image supplied from the motion prediction/compensation unit 161. In this way, the focus blur or the motion blur of the motion-compensated image can be compensated for.

Subsequently, the blur compensation unit 171 computes the cost function value of the motion-compensated and blur-compensated image obtained through the blur compensation process. The blur compensation unit 171 supplies the motion-compensated and blur-compensated image to the predicted image selecting unit 163 as the inter predicted image. In addition, the blur compensation unit 171 supplies the cost function value to the predicted image selecting unit 163. Thereafter, the blur prediction/compensation process is completed, and the processing returns to step S25 shown in FIG. 15. Subsequently, the processing proceeds to step S26.

As described above, the image encoding apparatus 151 performs not only motion compensation but also blur compensation in inter prediction. Accordingly, even when blur occurs or is removed from between the image to be inter predicted and the reference image, the inter prediction can be performed more accurately. Thus, the quality of the inter predicted image (e.g., the PSNR of the inter predicted image with respect to the image to be inter predicted) can be increased.

When blur compensation is performed in inter prediction, the blur information needs to be transmitted to the image decoding apparatus. Therefore, the bit length of the header portion of the compressed image is increased. However, since, as described above, the quality of the inter predicted image is increased, the difference between the image to be inter predicted and the inter predicted image is reduced. As a result, as a whole, the data amount of the compression information, that is, the amount of code is reduced and, thus, the coding efficiency may be increased.

More specifically, if the number of possible values of each of the radius L and the lengths Lx and by is N, the bit lengths required for the blur information is 3×Log 2(N). Accordingly, if, for example, N is 16, the bit lengths required for the blur information is 3×Log 2(16)=12. Therefore, in this case, if the amount of code of the compressed image is reduced by more than or equal to 12 bits by performing blur compensation, the amount of code of the compression information is reduced as a whole.

In addition, since the image encoding apparatus 151 performs blur compensation by applying an FIR filter corresponding to the radius L or the lengths Lx and Ly, focus blur or motion blur that can be defined as the radius L and the lengths Lx and Ly can be compensated for. As a result, the quality of the inter predicted image can be maintained even for images captured by a video camera having an auto focus control function and having frequently varying focus and images having varying motion blur due to camera shake at image capturing time.

Note that this can apply to the case in which the blur information indicates the spreading width W.

The compression information encoded by the image encoding apparatus 151 in this manner is transmitted via a predetermined transmission path and is decoded by the image decoding apparatus.

### [Example of Configuration of Image Decoding Apparatus]

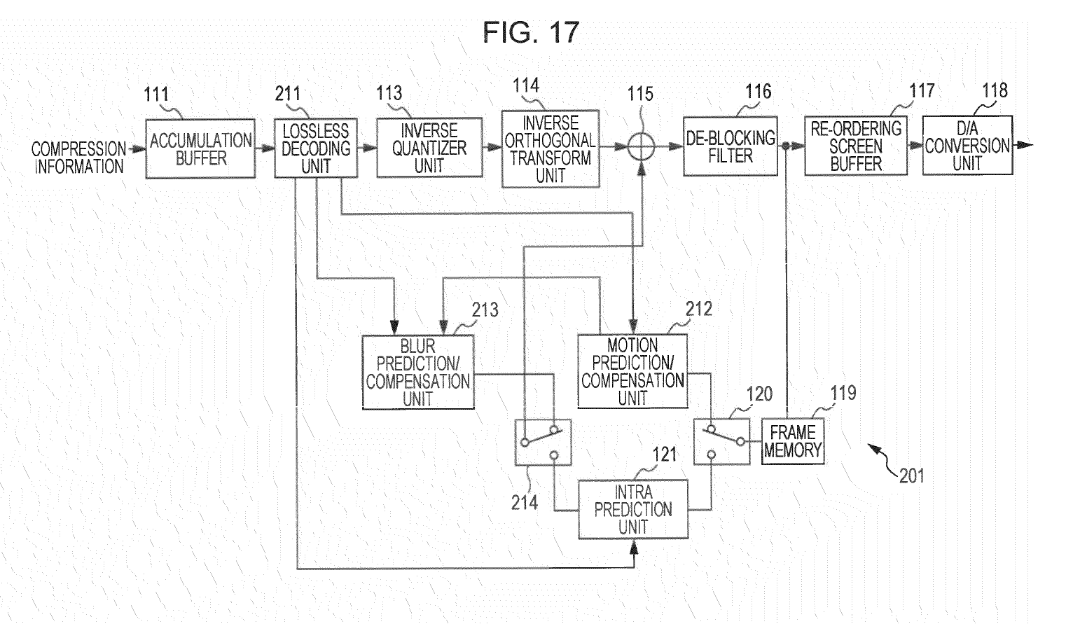

FIG. 17 illustrates an example configuration of such an image decoding apparatus.

The same numbering will be used in referring to the configuration in FIG. 17 as is utilized above in describing the configuration in FIG. 5. The same descriptions are not repeated.

The configuration of an image decoding apparatus 201 shown in FIG. 17 differs from the configuration shown in FIG. 5 in that the image decoding apparatus 201 includes a lossless decoding unit 211, a motion prediction/compensation unit 212, and a switch 214 in place of the lossless decoding unit 112, the motion prediction/compensation unit 122, and the switch 123 and additionally includes a blur prediction/compensation unit 213.

More specifically, the lossless decoding unit 211 of the image decoding apparatus 201 shown in FIG. 17 lossless decodes, using a method corresponding to the lossless encoding method employed by the lossless encoding unit 164, the compression information lossless-encoded by the lossless encoding unit 164 shown in FIG. 6 and supplied from the accumulation buffer 111. Thereafter, the lossless decoding unit 211 extracts, from information obtained through the lossless decoding, the image, the information indicating the optimal inter prediction mode or the optimal intra prediction mode, the motion vector information, the reference frame information, and the blur information.

Like the motion prediction/compensation unit 122 shown in FIG. 5, the motion prediction/compensation unit 212 receives information obtained by lossless decoding the header portion (e.g., the information indicating the optimal inter prediction mode, the motion vector information, and the reference frame information) supplied from the lossless decoding unit 211. If information indicating the optimal inter prediction mode is supplied, the motion prediction/compensation unit 212, like the motion prediction/compensation unit 122, performs the motion compensation process on the reference image received from the frame memory 119 in the optimal inter prediction mode on the basis of the motion vector information and the reference frame information received together with the information indicating the optimal inter prediction mode. Thereafter, the motion prediction/compensation unit 212 outputs the resultant motion-compensated image to the blur prediction/compensation unit 213.

The blur prediction/compensation unit 213 receives, from the lossless decoding unit 211, the blur information obtained when the lossless decoding unit 211 lossless decodes the header portion. The blur prediction/compensation unit 213 performs a blur compensation process on the motion-compensated image supplied from the motion prediction/compensation unit 212 on the basis of the blur information. Thereafter, the blur prediction/compensation unit 213 outputs the motion compensated and blur compensated image to the switch 214 as the inter predicted image.

The switch 214 supplies the inter predicted image supplied from the blur prediction/compensation unit 213 or the intra predicted image supplied from the intra prediction unit 121 to the computing unit 115.

As described above, since the image decoding apparatus 201 performs not only motion compensation but also blur compensation in the inter prediction, the image decoding apparatus 201 can perform inter prediction more accurately even when blur occurs between an image to be inter predicted and the reference image. Thus, the quality of an inter predicted image can be increased.

### [Example of Detailed Configuration of Blur Prediction/Compensation Unit 213]

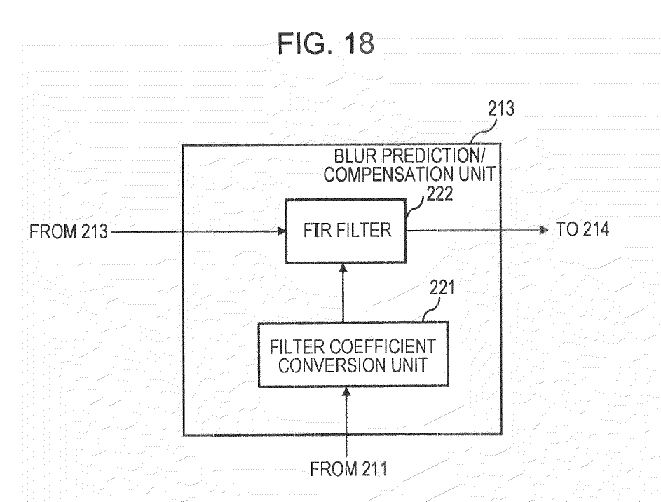

FIG. 18 illustrates an example of the detailed configuration of the blur prediction/compensation unit 213 shown in FIG. 17.

As shown in FIG. 18, the blur prediction/compensation unit 213 includes a filter coefficient conversion unit 221 and an FIR filter 222.

The filter coefficient conversion unit 221 converts the blur information supplied from the lossless decoding unit 211 into a filter coefficient. That is, the filter coefficient conversion unit 221 determines the filter coefficient on the basis of the blur information supplied from the lossless decoding unit 211.

For example, the filter coefficient conversion unit 221 converts blur information indicating the radius L shown in “A” of FIG. 10 into the filter coefficients corresponding to the values shown in “B” of FIG. 10. In addition, the filter coefficient conversion unit 221 converts blur information indicating the lengths Lx and Ly shown in “A” of FIG. 11 into the filter coefficients corresponding to the values shown in “B” of FIG. 11. Note that blur information indicating the spreading width W is similarly converted into the filter coefficients. Thereafter, the filter coefficient conversion unit 221 supplies the converted filter coefficients to the FIR filter 222.

The FIR filter 222 has characteristics determined by the filter coefficients supplied from the filter coefficient conversion unit 221. The FIR filter 222 performs the blur compensation process by filtering the motion-compensated image supplied from the motion prediction/compensation unit 212 using the filter coefficients. Thereafter, the FIR filter 222 supplies the obtained motion compensated and blur compensated image to the switch 214 as the inter predicted image.

As described above, since the blur prediction/compensation unit 213 performs the blur compensation process using an FIR filter having the filter coefficients corresponding to the blur information used for encoding and transmitted from the image encoding apparatus 151, the blur prediction/compensation unit 213 can perform a blur compensation process that is the same as that performed in the encoding process.

### [Description of Decoding Process]

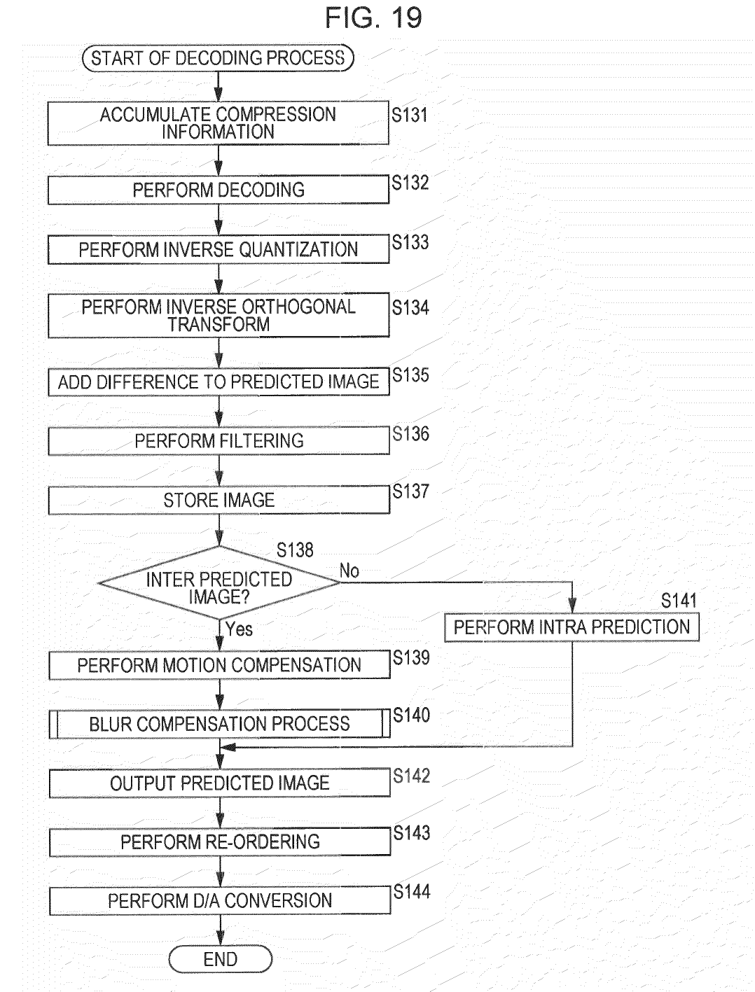

The decoding process performed by the image decoding apparatus 201 shown in FIG. 17 is described next with reference to a flowchart shown in FIG. 19.

In step S131, the accumulation buffer 111 accumulates the transmitted compression information. In step S132, the lossless decoding unit 211 lossless decodes the compression information supplied from the accumulation buffer 111. That is, an I picture, a P picture, and a B picture lossless encoded by the lossless encoding unit 164 shown in FIG. 6 are lossless decoded. Note that at that time, the motion vector information, the reference frame information, the information indicating the optimal intra prediction mode or the optimal inter prediction mode, and the blur information are also decoded.

In step S133, the inverse quantizer unit 113 inverse quantizes the transform coefficient lossless decoded by the lossless decoding unit 211 using characteristics corresponding to those of the quantizer unit 65 shown in FIG. 6. In step S134, the inverse orthogonal transform unit 114 inverse orthogonal transforms the transform coefficient inverse quantized by the inverse quantizer unit 113 using characteristics corresponding to those of the orthogonal transform unit 64 shown in FIG. 6. In this way, the difference serving as the input of the orthogonal transform unit 64 shown in FIG. 6 (the output of the computing unit 63) is decoded.

In step S135, the computing unit 115 adds the decoded difference to the inter predicted image or the intra predicted image output from the switch 214 in step S142 described below. In this way, a decoded original image can be obtained. In step S136, the de-blocking filter 116 filters the image output from the computing unit 115. Thus, block distortion is removed. In step S137, the frame memory 119 stores the filtered image.

In step S138, the lossless decoding unit 211 determines whether the compressed image is an inter predicted image, that is, whether the lossless decoded result includes information indicating the optimal inter prediction mode.

If, in step S138, it is determined that the compressed image is an inter predicted image, the lossless decoding unit 211 supplies the motion vector information, the reference frame information, and the information indicating the optimal inter prediction mode to the motion prediction/compensation unit 212. In addition, the lossless decoding unit 211 supplies the blur information to the blur prediction/compensation unit 213.

Subsequently, in step S139, the motion prediction/compensation unit 212 performs a motion compensation process on the reference image received from the frame memory 119 in the optimal inter prediction mode indicated by the information received from the lossless decoding unit 211 on the basis of the motion vector information indicated by the information and the reference frame information. Thereafter, the motion prediction/compensation unit 212 outputs the resultant motion-compensated image to the blur prediction/compensation unit 213.

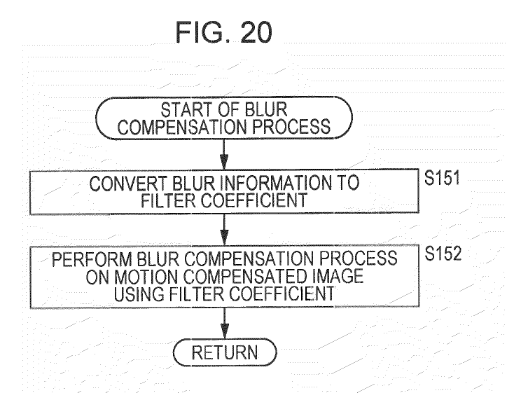

In step S140, the blur prediction/compensation unit 213 performs a blur compensation process on the motion-compensated image supplied from the motion prediction/compensation unit 212 on the basis of the blur information received from the lossless decoding unit 211. The blur compensation process is described in more detail below with reference to FIG. 20.

However, if, in step S138, it is determined that the compressed image is not an inter predicted image, that is, the lossless decoded result includes information indicating the optimal intra prediction mode, the lossless decoding unit 211 supplies the information indicating the optimal intra prediction mode to the intra prediction unit 121. Thereafter, in step S141, the intra prediction unit 121 performs an intra prediction process on the image received from the frame memory 119 in the optimal intra prediction mode indicated by the information received from the lossless decoding unit 211. Thus, the intra prediction unit 121 generates an intra predicted image. Subsequently, the intra prediction unit 121 outputs the intra predicted image to the switch 214.

After the process in step S140 or S141 is performed, the switch 214, in step S142, outputs the inter predicted image supplied from the blur prediction/compensation unit 213 or the intra predicted image supplied from the intra prediction unit 121 to the computing unit 115. In this way, as described above, in step S135, the inter predicted image or the intra predicted image is added to the output of the inverse orthogonal transform unit 114.

In step S143, the re-ordering screen buffer 117 re-orders images. That is, the order of frames that has been changed by the re-ordering screen buffer 62 of the image encoding apparatus 151 for encoding is changed back to the original display order.

In step S144, the D/A conversion unit 118 D/A-converts the image supplied from the re-ordering screen buffer 117 and outputs the image to a display (not shown), which displays the image.

### [Detailed Description of Blur Compensation Process]

The blur compensation process performed in step S140 shown in FIG. 19 is described next with reference to a flowchart shown in FIG. 20.

In step S151, the filter coefficient conversion unit 221 (see FIG. 18) of the blur prediction/compensation unit 213 converts the blur information received from the lossless decoding unit 211 into filter coefficients and supplies the filter coefficients to the FIR filter 222.

In step S152, the FIR filter 222 filters the motion-compensated image supplied from the filter coefficient conversion unit 221 using the filter coefficients supplied from the motion prediction/compensation unit 212. In this way, the FIR filter 222 performs the blur compensation process. The FIR filter 222 outputs the resultant motion compensated and blur compensated image to the switch 214 as the inter predicted image. Thereafter, the blur compensation process is completed. Subsequently, the processing returns to step S140 shown in FIG. 19 and proceeds to step S142.

### 3. Second Embodiment

### Example of Configuration of Image Encoding Apparatus

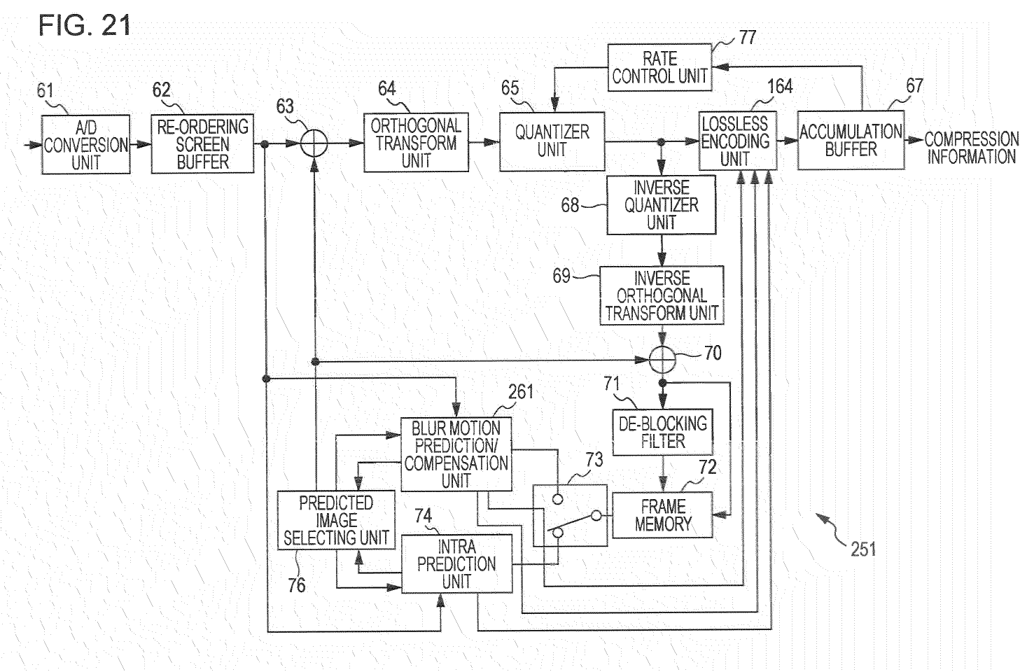

Next, FIG. 21 illustrates an example of the configuration of an image encoding apparatus according to a second embodiment of the present invention.

The same numbering will be used in referring to the configuration in FIG. 21 as is utilized above in describing the configuration in FIGS. 3 and 6. The same descriptions are not repeated.

The configuration of an image encoding apparatus 251 shown in FIG. 21 mainly differs from the configuration shown in FIG. 3 in that the image encoding apparatus 251 includes a blur motion prediction/compensation unit 261 and the lossless encoding unit 164 in place of the motion prediction/compensation unit 75 and the lossless encoding unit 66.

More specifically, the blur motion prediction/compensation unit 261 of the image encoding apparatus 251 shown in FIG. 21 performs a blur motion prediction/compensation process on the basis of an image to be inter predicted read from the re-ordering screen buffer 62 and an image serving as the reference image supplied from the frame memory 72 via the switch 73. Note that the term “blur motion prediction/compensation process” refers to a process in which a blur prediction/compensation process and a motion prediction/compensation process in all the candidate inter prediction modes are performed at the same time.

In addition, the blur motion prediction/compensation unit 261 selects, as an optimal inter prediction mode, the inter prediction mode of a blur predicted/compensated image that minimizes the difference from the image to be inter predicted. Thereafter, the blur motion prediction/compensation unit 261 supplies the image to the predicted image selecting unit 76 as the inter predicted image. The blur motion prediction/compensation unit 261 computes the cost function value of the inter predicted image and supplies the cost function value to the predicted image selecting unit 76.

Furthermore, if the predicted image selecting unit 76 selects the inter predicted image, the blur motion prediction/compensation unit 261 outputs, to the lossless encoding unit 164, the information indicating the optimal inter prediction mode, information associated with the optimal inter prediction mode (e.g., the motion vector information and the reference frame information), and the blur information used for generating the inter predicted image.

### [Example of Configuration of Blur Motion Prediction/Compensation Unit 261]

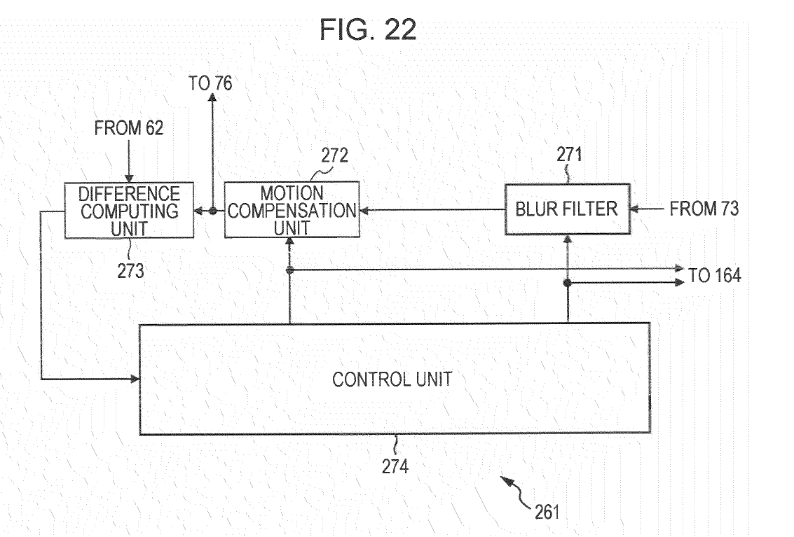

FIG. 22 illustrates an example configuration of the blur motion prediction/compensation unit 261 shown in FIG. 21.

As shown in FIG. 22, the blur motion prediction/compensation unit 261 includes a blur filter 271, a motion compensation unit 272, a difference computing unit 273, and a control unit 274.

The blur filter 271 performs blur compensation by filtering the image serving as the reference image supplied from the switch 73 using the filter coefficients corresponding to the blur information supplied from the control unit 274. Thereafter, the blur filter 271 supplies the resultant blur compensated image to the motion compensation unit 272.

The motion compensation unit 272 performs motion compensation on the blur compensated image received from the blur filter 271 in the inter prediction mode received from the control unit 274 on the basis of the motion vector received from the control unit 274. Thereafter, the motion compensation unit 272 supplies the resultant blur compensated and motion compensated image to the difference computing unit 273. In addition, under the control of the control unit 274, the motion compensation unit 272 supplies, to the predicted image selecting unit 76, a blur compensated and motion compensated image obtained through motion compensation based on a predetermined motion vector in the optimal inter prediction mode as an inter predicted image. Furthermore, the motion compensation unit 272 computes the cost function value of the inter predicted image and supplies the cost function value to the predicted image selecting unit 76.

The difference computing unit 273 computes the difference between the image received from the motion compensation unit 272 and the image to be inter predicted corresponding to the image and received from the re-ordering screen buffer 62. Thereafter, the difference computing unit 273 supplies the difference to the control unit 274.

The control unit 274 sequentially supplies a plurality of predetermined blur information items to the blur filter 271. The control unit 274 estimates blur information acquired when the difference received from the difference computing unit 273 is minimized as the blur information regarding the image to be inter predicted. Thereafter, the control unit 274 supplies the blur information to the blur filter 271 and the lossless encoding unit 164.

In addition, the control unit 274 sequentially supplies a plurality of predetermined motion vectors to the motion compensation unit 272 and sequentially supplies all of the candidate inter prediction modes to the motion compensation unit 272. The control unit 274 selects the inter prediction mode obtained when the difference received from the difference computing unit 273 is minimized as the optimal inter prediction mode and estimates the motion vector as the motion vector of the image to be inter predicted. Thereafter, the control unit 274 supplies the optimal inter prediction mode and the motion vector to the motion compensation unit 272. In this way, the blur compensated and motion compensated image obtained through motion compensation based on the predetermined motion vector in the optimal inter prediction mode is supplied to the predicted image selecting unit 76.

Furthermore, the control unit 274 estimates a motion vector obtained when the difference received from the difference computing unit 273 is minimized as a motion vector of the image to be inter predicted. Thereafter, the control unit 274 supplies the motion vector information, the reference frame information, and the optimal inter prediction mode to the lossless encoding unit 164.

In this way, the blur motion prediction/compensation unit 261 performs blur compensation and motion compensation. Thereafter, the blur motion prediction/compensation unit 261 selects the image having a minimum difference from the image to be inter predicted as the inter predicted image. That is, the blur motion prediction/compensation unit 261 performs a blur prediction/compensation process and a motion prediction/compensation process at the same time. Accordingly, an image having an optimal combination of the blur compensation and motion compensation can be selected as the inter predicted image. As a result, the accuracy of inter prediction can be further increased. However, in order to perform a blur prediction/compensation process and a motion prediction/compensation process at the same time, a motion prediction/compensation process needs to be performed on a plurality of blur compensated images. Therefore, the search area for the entire motion prediction/compensation is increased and, thus, the amount of processing increases.

Note that in the image encoding apparatus 251, the blur motion prediction/compensation process in which a motion prediction/compensation process is performed for all of the candidate inter prediction modes simultaneously with the blur prediction/compensation process is performed. However, after the prediction/compensation process is performed, the blur motion prediction/compensation process may be performed for all of the candidate inter prediction modes.

In such a case, the image encoding apparatus has a configuration obtained by switching the motion prediction/compensation unit 161 and the blur prediction/compensation unit 162 in the image encoding apparatus 151 shown in FIG. 6. In this case, since a motion prediction/compensation process can be performed using the blur compensated image, the accuracy of inter prediction can be increased, as compared with the case in which blur prediction/compensation is performed after motion prediction/compensation has been performed.

More specifically, in the motion prediction/compensation process, only translation of an image is taken into account as a change between images. Therefore, when motion prediction/compensation is performed using images not having a variation in the frequency characteristic between the images after blur compensation has been performed, the difference between the images due to blur can be reduced. Accordingly, the motion vector that coincides with the motion of a subject can be easily detected. In this way, since the blur prediction/compensation process functions so that the quality of the motion prediction/compensation is improved, the accuracy of inter prediction can be increased.

In contrast, when the motion prediction/compensation process is performed using a reference image that is not subjected to the blur prediction/compensation process and if, for example, the reference image has no blur and an image to be inter predicted has blur, a difference occurs between the reference image that has been motion compensated on the basis of a motion vector and the image to be inter predicted even when the motion of a subject coincides with the motion vector. Therefore, a motion vector that coincides with the motion of the intra predicted image may not be detected.

In such a case, the inter predicted image corresponding to a motion vector having no relationship with the motion of the subject or the intra predicted image is employed as a predicted image. Thus, in general, the quality of the predicted image is decreased.

However, in the case in which a motion prediction/compensation process is performed after a blur prediction/compensation process has been performed and motion is detected between images, even when a blur compensated image corresponding to actual blur is used, a difference between the blur compensated image and the image to be inter predicted may not be small in blur prediction. Therefore, it is difficult to predict blur.

In contrast, if, as in the image encoding apparatus 151, the motion prediction/compensation process is performed before the blur prediction/compensation process is performed, an image used for the blur prediction/compensation process is the motion-compensated image. Therefore, blur can be easily predicted.

### [Description of Encoding Process]

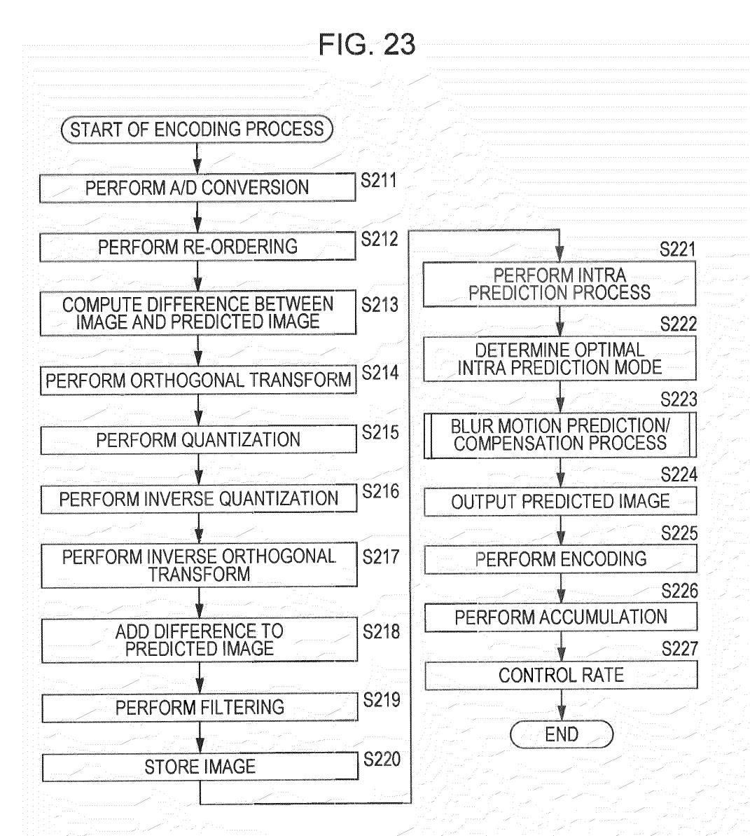

The encoding process performed by the image encoding apparatus 251 shown in FIG. 21 is described next with reference to a flowchart shown in FIG. 23.

The encoding process shown in FIG. 23 mainly differs from that shown in FIG. 15 in that step S223 is provided in FIG. 23 instead of steps S23 to S25 in FIG. 15. Accordingly, only step S223 is described in detail below.

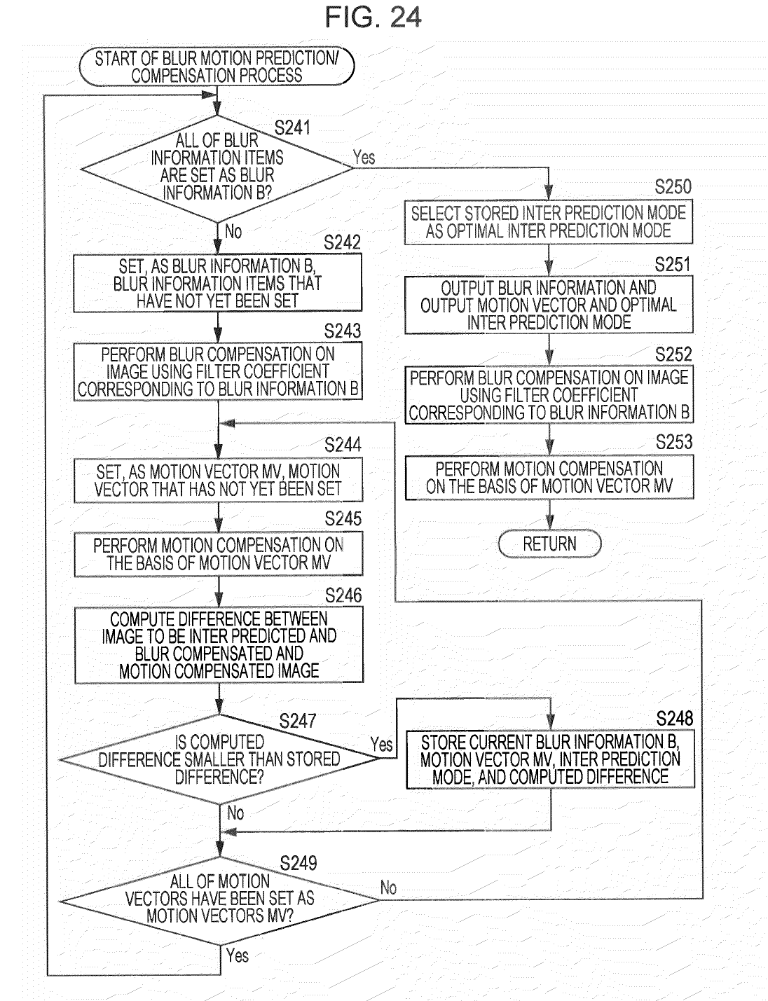

In step S223, the blur motion prediction/compensation unit 261 performs a motion blur prediction/compensation process on the image supplied from the switch 73. The motion blur prediction/compensation process is described in more detail below with reference to FIG. 24.

### [Description of Blur Motion Prediction/Compensation Process]

The blur motion prediction/compensation process performed in step S223 shown in FIG. 23 is described next with reference to a flowchart shown in FIG. 24.

In step S241, the control unit 274 of the blur motion prediction/compensation unit 261 (see FIG. 22) determines whether all of the blur information items among predetermined blur information items are set as blur information B to be transmitted to the blur filter 271. If, in step S241, it is determined that all of the blur information items among predetermined blur information items have not been set as the blur information B, the processing proceeds to step S242.

In step S242, the control unit 274 sets, as the blur information B, the blur information items that have not yet been set as the blur information B. Thereafter, the control unit 274 supplies the blur information B to the blur filter 271. In step S243, the blur filter 271 performs blur compensation by filtering the image supplied from the switch 73 using the filter coefficient corresponding to the blur information B supplied from the control unit 274. The blur filter 271 supplies the resultant blur compensated image to the motion compensation unit 272.

In step S244, from among preset motion vectors, the control unit 274 sets a motion vector that has not yet been set for the blur information B as a motion vector MV to be supplied to the motion compensation unit 272. Thereafter, the control unit 274 supplies the motion vector MV to the motion compensation unit 272. In addition, at that time, the control unit 274 sequentially supplies all of the candidate inter prediction modes to the motion compensation unit 272.

In step S245, the motion compensation unit 272 performs motion compensation on the blur compensated image supplied from the blur filter 271 in each of the inter prediction modes sequentially supplied from the control unit 274 on the basis of the motion vector MV supplied from the control unit 274. Thereafter, the motion compensation unit 272 supplies the resultant blur compensated and motion compensated image to the difference computing unit 273.

In step S246, the difference computing unit 273 computes a difference between the image to be inter predicted supplied from the re-ordering screen buffer 62 and the blur compensated and motion compensated image supplied from the motion compensation unit 272 and supplies the difference to the control unit 274.

In step S247, the control unit 274 determines whether the difference computed in step S246 is smaller than the difference stored in an internal memory (not shown). If, in step S247, it is determined that the difference computed in step S246 is smaller than the difference stored in an internal memory (not shown), the processing proceeds to step S248. However, if the difference is computed in step S246 that is performed first, the processing also proceeds to step S248.

In step S248, the control unit 274 stores the current blur information B, the motion vector MV, the difference computed in step S246, and the inter prediction mode corresponding to the difference in an internal memory (not shown). Thereafter, the processing proceeds to step S249. Note that the processing in steps S247 and S248 is performed for each of the inter prediction modes.

However, if, in step S247, it is determined that the difference computed in step S246 is not smaller than the stored difference, step S248 is skipped and the processing proceeds to step S249. In step S249, the control unit 274 determines whether all of the preset motion vectors have been set as the motion vectors MV.

If, in step S249, it is determined that all of the preset motion vectors have not yet been set as the motion vectors MV, the processing returns to step S244 and the subsequent processes are repeated.

However, if, in step S249, it is determined that all of the preset motion vectors have been set as the motion vectors MV, the processing returns to step S241 and the subsequent processes are repeated.

In contrast, if, in step S241, it is determined that all of the preset blur information items have been set as the blur information B, the processing proceeds to step S250. In step S250, the control unit 274 selects the inter prediction mode stored in an internal memory (not shown) as the optimal inter prediction mode.

In step S251, the control unit 274 selects the blur information stored in the internal memory (not shown) as the blur information B and outputs the blur information B to the blur filter 271. In addition, the control unit 274 outputs the motion vector representing the stored motion vector MV and the optimal inter prediction mode to the motion compensation unit 272.

In step S252, the blur filter 271 performs blur compensation by filtering the image supplied from the switch 73 using the filter coefficient corresponding to the blur information B supplied from the control unit 274 in step S251. The blur filter 271 supplies the resultant blur compensated image to the motion compensation unit 272.

In step S253, the motion compensation unit 272 performs motion compensation on the blur compensated image supplied from the blur filter 271 using the motion vector MV supplied from the control unit 274 in step S251. Thereafter, the motion compensation unit 272 supplies the resultant blur compensated and motion compensated image to the predicted image selecting unit 76 as the inter predicted image. At that time, the motion compensation unit 272 computes the cost function value of the inter predicted image and supplies the cost function value to the predicted image selecting unit 76. Thereafter, the processing returns to step S223 shown in FIG. 23 and proceeds to step S224.

The compression information encoded by the image encoding apparatus 251 in this manner is transmitted via a predetermined transmission path and is decoded by the image decoding unit.

### [Example of Configuration of Decoding Apparatus]

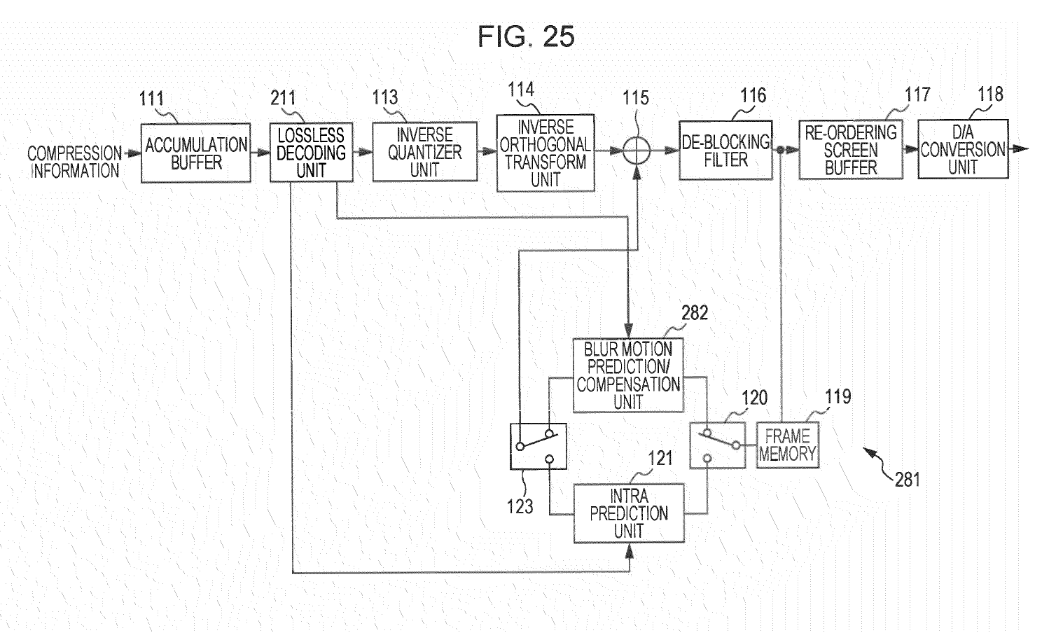

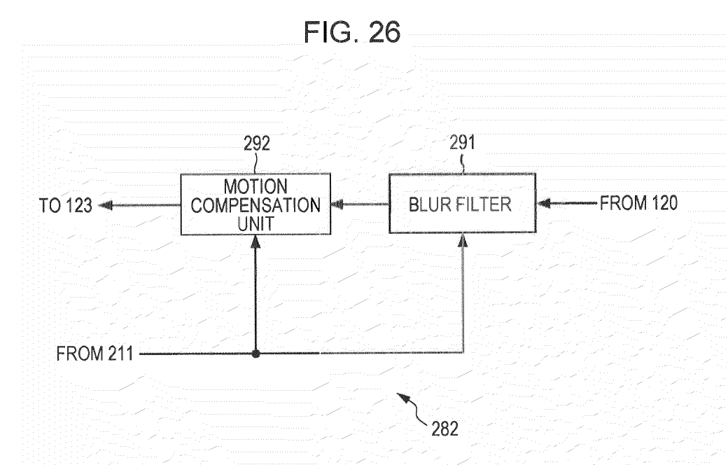

FIG. 25 illustrates an example configuration of such an image decoding apparatus.

The same numbering will be used in referring to the configuration in FIG. 25 as is utilized above in describing the configuration in FIGS. 5 and 17. The same descriptions are not repeated as needed.

The configuration of an image decoding apparatus 281 shown in FIG. 25 mainly differs from the configuration shown in FIG. 5 in that the image decoding apparatus 281 includes a blur motion prediction/compensation unit 282, a blur motion prediction/compensation unit 282, and a lossless decoding unit 211 in place of the motion prediction/compensation unit 122 and the lossless decoding unit 112.

More specifically, the blur motion prediction/compensation unit 282 of the image decoding apparatus 281 shown in FIG. 25 receives, from the lossless decoding unit 211, information obtained by lossless decoding the header portion (e.g., the information indicating the optimal inter prediction mode, the motion vector information, the reference frame information, and the blur information). The blur motion prediction/compensation unit 282 performs a blur motion compensation process (described in more detail below) on the image serving as a reference image supplied from the switch 120 on the basis of the information indicating the optimal inter prediction mode, the motion vector information, the reference frame information, and the blur information.

Subsequently, the blur motion prediction/compensation unit 282 supplies, as an inter predicted image, the resultant blur compensated and motion compensated image to the computing unit 115 via the switch 123. Note that the term “blur motion compensation process” refers to a process in which motion compensation is performed in a predetermined inter prediction mode at the same time as blur compensation is performed.

### [Example of Configuration of Blur Motion Prediction/Compensation Unit 282]

FIG. 26 illustrates a detailed example configuration of the blur motion prediction/compensation unit 282 shown in FIG. 25.

As shown in FIG. 26, the blur motion prediction/compensation unit 282 includes a blur filter 291, a blur filter 291, and a motion compensation unit 292.

The blur filter 291 performs blur compensation by filtering the image serving as a reference image supplied from the switch 120 using the filter coefficient corresponding to the blur information supplied from the lossless decoding unit 211. Thereafter, the blur filter 291 supplies the resultant blur compensated image to the motion compensation unit 292.

The motion compensation unit 292 performs motion compensation on the blur compensated image received from the blur filter 291 on the basis of the motion vector information, the reference frame information, and the information indicating the optimal inter prediction mode supplied from the lossless decoding unit 211. The motion compensation unit 292 supplies the resultant blur compensated and motion-compensated image to the switch 123 as the inter predicted image.

### [Description of Decoding Process]

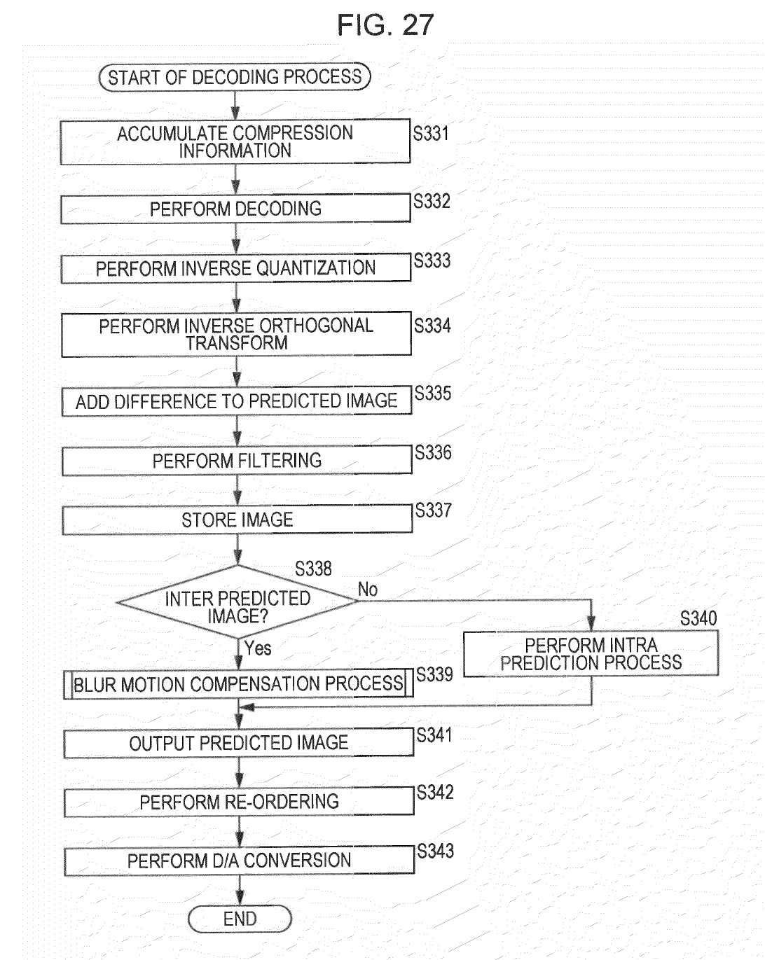

The decoding process performed by the image decoding apparatus 281 shown in FIG. 25 is described next with reference to a flowchart shown in FIG. 27.

The decoding process shown in FIG. 27 differs from that shown in FIG. 19 in that step S339 is provided in FIG. 27 instead of steps S139 and S140 shown in FIG. 19. Accordingly, only step S339 is described in detail below.

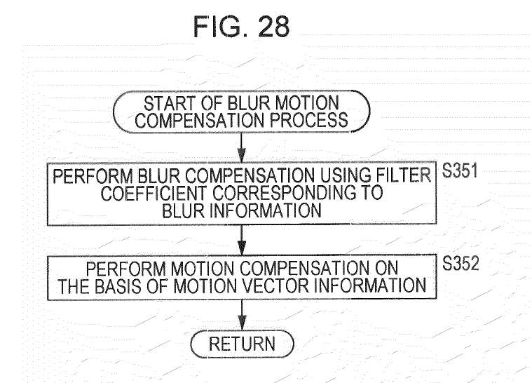

In step S339, the blur motion prediction/compensation unit 282 performs the blur motion compensation process on the image supplied from the switch 120. The blur motion compensation process is described in more detail below with reference to FIG. 28.

### [Description of Motion Blur Prediction/Compensation Process]

The blur motion compensation process performed in step S339 shown in FIG. 27 is described next with reference to a flowchart shown in FIG. 28.

In step S351, the blur filter 291 of the blur motion prediction/compensation unit 282 performs blur compensation by filtering the image supplied from the switch 120 using the filter coefficient corresponding to the blur information supplied from the lossless decoding unit 211. Thereafter, the blur filter 291 supplies the resultant blur compensated image to the motion compensation unit 292.

In step S352, the motion compensation unit 292 performs motion compensation on the blur compensated image received from the blur filter 291 in the optimal inter prediction mode indicated by the information received from the lossless decoding unit 211 on the basis of the motion vector information and the reference frame information received together with the information. The motion compensation unit 292 supplies the resultant blur compensated and motion-compensated image to the switch 123 as the inter predicted image. Thereafter, the processing returns to step S339 shown in FIG. 27 and proceeds to step S341.

Note that while the above description has been made with reference to the filter coefficient varied in accordance with the blur information, the filter structure may be varied.

Note that while the above description has been made with reference to a macroblock having a size of 16×16 pixels, the present invention can be applied to the extended macroblock size described in “Video Coding Using Extended Block Sizes”, VCEG-AD09, ITU-Telecommunications Standardization Sector STUDY GROUP Question 16-Contribution 123, January 2009.

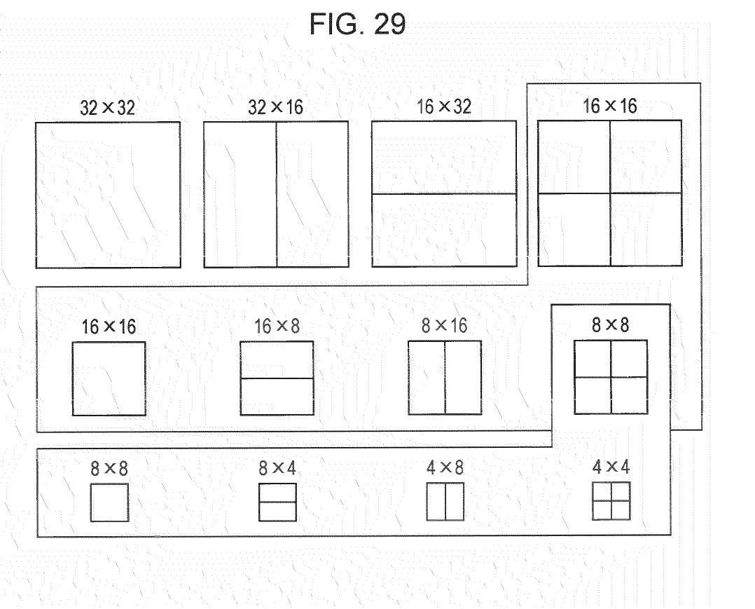

FIG. 29 illustrates an example of the extended macroblock size. In the above description, the macroblock size is extended to a size of 32×32 pixels.

In the upper section of FIG. 29, macroblocks that have a size of 32×32 pixels and that are partitioned into blocks (partitions) having sizes of 32×32 pixels, 32×16 pixels, 16×32 pixels, and 16×16 pixels are shown from the left. In the middle section of FIG. 29, macroblocks that have a size of 16×16 pixels and that are partitioned into blocks having sizes of 16×16 pixels, 16×8 pixels, 8×16 pixels, and 8×8 pixels are shown from the left. In the lower section of FIG. 29, macroblocks that have a size of 8×8 pixels and that are partitioned into blocks having sizes of 8×8 pixels, 8×4 pixels, 4×8 pixels, and 4×4 pixels are shown from the left.

That is, the macroblock having a size of 32×32 can be processed using the blocks having sizes of 32×32 pixels, 32×16 pixels, 16×32 pixels, and 16×16 pixels shown in the upper section of FIG. 29.

In addition, as in the H.264/AVC standard, the block having a size of 16×16 pixels shown on the right in the upper section can be processed using the blocks having sizes of 16×16 pixels, 16×8 pixels, 8×16 pixels, and 8×8 pixels shown in the middle section.

Furthermore, as in the H.264/AVC standard, the block having a size of 8×8 pixels shown on the right in the middle section can be processed using the blocks having sizes of 8×8 pixels, 8×4 pixels, 4×8 pixels, and 4×4 pixels shown in the lower section.

In terms of the extended macroblock size, by employing such a layer structure, for a block having a size smaller than or equal to 16×16 pixels, a block having a larger size can be defined as a superset of the block while maintaining compatibility with the H.264/AVC standard.

As described above, the present invention can be applied to the proposed extended macroblock size.

While the above description has been made with reference to the H.264/AVC standard as an encoding/decoding method, the present invention is applicable to an image encoding apparatus and an image decoding apparatus using an encoding/decoding method in which a different motion prediction/compensation process is performed.

In addition, the present invention is applicable to an image encoding apparatus and an image decoding apparatus used for receiving image information (a bit stream) compressed through the orthogonal transform (e.g., discrete cosine transform) and motion compensation as in the MPEG or H.26x standard via a network medium, such as satellite broadcasting, a cable TV (television), the Internet, or a cell phone or processing image information in a storage medium such as an optical or magnetic disk, or a flash memory.

In particular, the present invention is effective for processing an image in which blur continuously varies.

The above-described series of processes can be executed not only by hardware but also by software. When the above-described series of processes are executed by software, the programs of the software are installed from a program recording medium into a computer incorporated into dedicated hardware or a computer that can execute a variety of functions by installing a variety of programs therein (e.g., a general-purpose personal computer).

Examples of the program recording medium that records a computer-executable program to be installed in a computer include a magnetic disk (including a flexible disk), an optical disk (including a CD-ROM (Compact Disc-Read Only Memory), a DVD (Digital Versatile Disc), and a magnetooptical disk), a removable medium which is a package medium formed from a semiconductor memory), and a ROM and a hard disk that temporarily or permanently stores the programs. The programs are recorded in the program recording medium using a wired or wireless communication medium, such as a local area network, the Internet, or digital satellite broadcasting, as needed.

In the present specification, the steps that describe the program include not only processes executed in the above-described time-series sequence, but also processes that may be executed in parallel or independently.

In addition, embodiments of the present invention are not limited to the above-described embodiments. Various modifications can be made without departing from the spirit of the present invention.

For example, the above-described image encoding apparatuses 151 and 251 and image decoding apparatuses 201 and 281 are applicable to any electronic apparatus. Examples of such application are described below.

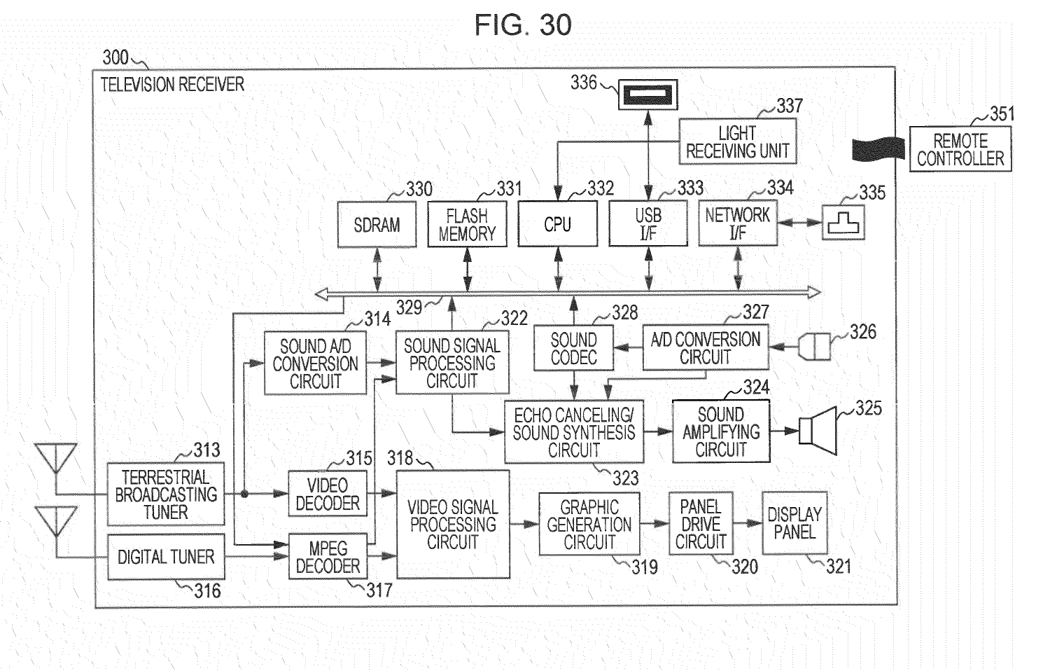

FIG. 30 is a block diagram of an example of the primary configuration of a television receiver using the image decoding apparatus according to the present invention.

As shown in FIG. 30, a television receiver 300 includes a terrestrial broadcasting tuner 313, a video decoder 315, a video signal processing circuit 318, a graphic generation circuit 319, a panel drive circuit 320, and a display panel 321.

The terrestrial broadcasting tuner 313 receives a broadcast signal of analog terrestrial broadcasting via an antenna, demodulates the broadcast signal, acquires a video signal, and supplies the video signal to the video decoder 315. The video decoder 315 performs a decoding process on the video signal supplied from the terrestrial broadcasting tuner 313 and supplies the resultant digital component signal to the video signal processing circuit 318.

The video signal processing circuit 318 performs a predetermined process, such as noise removal, on the video data supplied from the video decoder 315. Thereafter, the video signal processing circuit 318 supplies the resultant video data to the graphic generation circuit 319.

The graphic generation circuit 319 generates, for example, video data for a television program displayed on the display panel 321 and image data generated through the processing performed by an application supplied via a network. Thereafter, the graphic generation circuit 319 supplies the generated video data and image data to the panel drive circuit 320. In addition, the graphic generation circuit 319 generates video data (graphics) for displaying a screen used by a user who selects a menu item. The graphic generation circuit 319 overlays the video data on the video data of the television program. Thus, the graphic generation circuit 319 supplies the resultant video data to the panel drive circuit 320 as needed.

The panel drive circuit 320 drives the display panel 321 on the basis of the data supplied from the graphic generation circuit 319. Thus, the panel drive circuit 320 causes the display panel 321 to display the video of a television program and a variety of types of screen thereon.

The display panel 321 includes, for example, an LCD (Liquid Crystal Display). The display panel 321 displays, for example, the video of a television program under the control of the panel drive circuit 320.

The television receiver 300 further includes a sound A/D (Analog/Digital) conversion circuit 314, a sound signal processing circuit 322, an echo canceling/sound synthesis circuit 323, a sound amplifying circuit 324, and a speaker 325.

The terrestrial broadcasting tuner 313 demodulates a received broadcast signal. Thus, the terrestrial broadcasting tuner 313 acquires a sound signal in addition to the video signal. The terrestrial broadcasting tuner 313 supplies the acquired sound signal to the sound A/D conversion circuit 314.

The sound A/D conversion circuit 314 performs an A/D conversion process on the sound signal supplied from the terrestrial broadcasting tuner 313. Thereafter, the sound A/D conversion circuit 314 supplies the resultant digital sound signal to the sound signal processing circuit 322.

The sound signal processing circuit 322 performs a predetermined process, such as noise removal, on the sound data supplied from the sound A/D conversion circuit 314 and supplies the resultant sound data to the echo canceling/sound synthesis circuit 323.

The echo canceling/sound synthesis circuit 323 supplies the sound data supplied from the sound signal processing circuit 322 to the sound amplifying circuit 324.

The sound amplifying circuit 324 performs a D/A conversion process and an amplifying process on the sound data supplied from the echo canceling/sound synthesis circuit 323. After the sound data has a predetermined sound volume, the sound amplifying circuit 324 outputs the sound from the speaker 325.

The television receiver 300 further includes a digital tuner 316 and an MPEG decoder 317.

The digital tuner 316 receives a broadcast signal of digital broadcasting (terrestrial digital broadcasting and BS (Broadcasting Satellite)/CS (Communications Satellite) digital broadcasting) via an antenna and demodulates the broadcast signal. Thus, the digital tuner 316 acquires an MPEG-TS (Moving Picture Experts Group-Transport Stream) and supplies the MPEG-TS to the MPEG decoder 317.

The MPEG decoder 317 descrambles the MPEG-TS supplied from the digital tuner 316 and extracts a stream including television program data to be reproduced (viewed). The MPEG decoder 317 decodes sound packets of the extracted stream and supplies the resultant sound data to the sound signal processing circuit 322. In addition, the MPEG decoder 317 decodes video packets of the stream and supplies the resultant video data to the video signal processing circuit 318. Furthermore, the MPEG decoder 317 supplies EPG (Electronic Program Guide) data extracted from the MPEG-TS to a CPU 332 via a path (not shown).

The television receiver 300 uses the above-described image decoding apparatus 201 or 281 as the MPEG decoder 317 that decodes the video packets in this manner. Accordingly, like the image decoding apparatus 201 or 281, the MPEG decoder 317 performs not only motion compensation but also the blur compensation in inter prediction. Thus, even when blur appears or disappears between an image to be inter predicted and the reference image, the inter prediction can be performed more accurately. As a result, the quality of the inter predicted image can be increased.

Like the video data supplied from the video decoder 315, the video data supplied from the MPEG decoder 317 is subjected to a predetermined process in the video signal processing circuit 318. Thereafter, the video data subjected to the predetermined process is overlaid on the generated video data in the graphic generation circuit 319 as needed. The video data is supplied to the display panel 321 via the panel drive circuit 320, and the image based on the video data is displayed.

Like the sound data supplied from the sound A/D conversion circuit 314, the sound data supplied from the MPEG decoder 317 is subjected to a predetermined process in the sound signal processing circuit 322. Thereafter, the sound data subjected to the predetermined process is supplied to the sound amplifying circuit 324 via the echo canceling/sound synthesis circuit 323 and is subjected to a D/A conversion process and an amplifying process. As a result, sound controlled so as to have a predetermined volume is output from the speaker 325.

The television receiver 300 further includes a microphone 326 and an A/D conversion circuit 327.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the echo canceling/sound synthesis circuit 323.

When voice data of a user (a user A) of the television receiver 300 is supplied from the A/D conversion circuit 327, the echo canceling/sound synthesis circuit 323 performs echo canceling on the voice data of the user A. After echo canceling is completed, the echo canceling/sound synthesis circuit 323 synthesizes the voice data with other sound data. Thereafter, the echo canceling/sound synthesis circuit 323 outputs the resultant sound data from the speaker 325 via the sound amplifying circuit 324.

The television receiver 300 still further includes a sound codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the sound codec 328.

The sound codec 328 converts the sound data supplied from the A/D conversion circuit 327 into data having a predetermined format in order to send the sound data via a network. The sound codec 328 supplies the sound data to the network I/F 334 via the internal bus 329.

The network I/F 334 is connected to the network via a cable attached to a network terminal 335. For example, the network I/F 334 sends the sound data supplied from the sound codec 328 to a different apparatus connected to the network. In addition, for example, the network I/F 334 receives sound data sent from a different apparatus connected to the network via the network terminal 335 and supplies the received sound data to the sound codec 328 via the internal bus 329.

The sound codec 328 converts the sound data supplied from the network I/F 334 into data having a predetermined format. The sound codec 328 supplies the sound data to the echo canceling/sound synthesis circuit 323.

The echo canceling/sound synthesis circuit 323 performs echo canceling on the sound data supplied from the sound codec 328. Thereafter, the echo canceling/sound synthesis circuit 323 synthesizes the sound data with other sound data and outputs the resultant sound data from the speaker 325 via the sound amplifying circuit 324.

The SDRAM 330 stores a variety of types of data necessary for the CPU 332 to perform processing.

The flash memory 331 stores a program executed by the CPU 332. The program stored in the flash memory 331 is read out by the CPU 332 at a predetermined timing, such as when the television receiver 300 is powered on. The flash memory 331 further stores the EPG data received through digital broadcasting and data received from a predetermined server via the network.

For example, the flash memory 331 stores an MPEG-TS including content data acquired from a predetermined server via the network under the control of the CPU 332. The flash memory 331 supplies the MPEG-TS to the MPEG decoder 317 via the internal bus 329 under the control of, for example, the CPU 332.

As in the case of the MPEG-TS supplied from the digital tuner 316, the MPEG decoder 317 processes the MPEG-TS. In this way, the television receiver 300 receives content data including video and sound via the network and decodes the content data using the MPEG decoder 317. Thereafter, the television receiver 300 can display the video and output the sound.

The television receiver 300 still further includes a light receiving unit 337 that receives an infrared signal transmitted from a remote controller 351.

The light receiving unit 337 receives an infrared light beam emitted from the remote controller 351 and demodulates the infrared light beam. Thereafter, the light receiving unit 337 outputs, to the CPU 332, control code that is received through the demodulation and that indicates the type of the user operation.

The CPU 332 executes the program stored in the flash memory 331 and performs overall control of the television receiver 300 in accordance with, for example, the control code supplied from the light receiving unit 337. The CPU 332 is connected to each of the units of the television receiver 300 via a path (not shown).

The USB I/F 333 communicates data with an external device connected to the television receiver 300 via a USB cable attached to a USB terminal 336. The network I/F 334 is connected to the network via a cable attached to the network terminal 335 and also communicates non-sound data with a variety of types of device connected to the network.

By using the image decoding apparatus 201 or 281 as the MPEG decoder 317, the television receiver 300 can perform inter prediction more accurately. Thus, the quality of the inter predicted image can be increased. As a result, the television receiver 300 can acquire a higher-resolution decoded image from the broadcast signal received via the antenna or content data received via the network and display the decoded image.

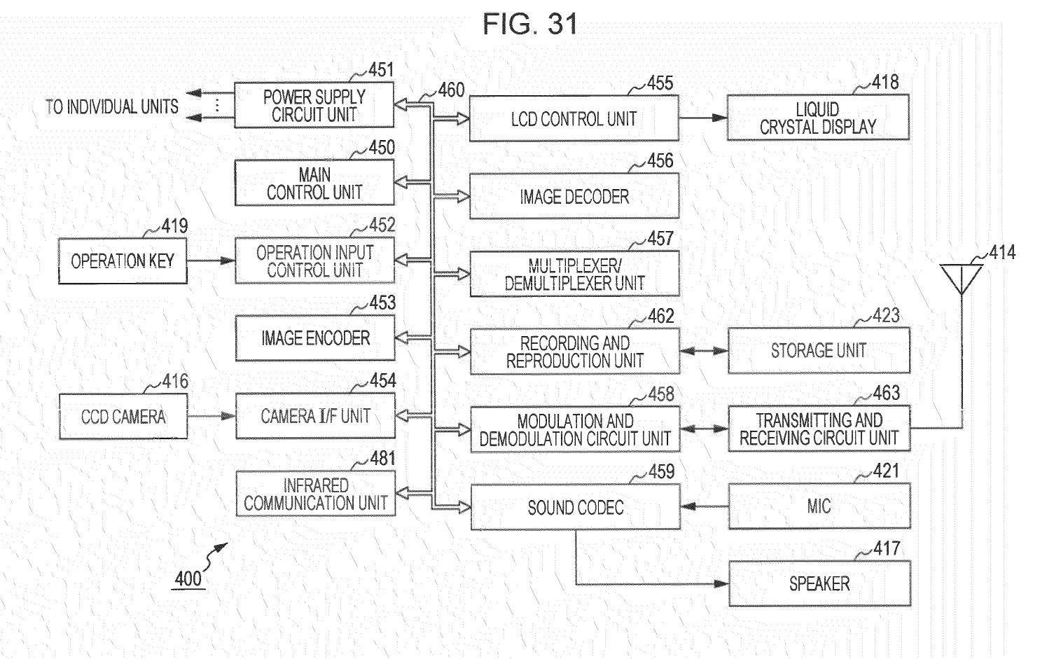

FIG. 31 is a block diagram of an example of a primary configuration of a cell phone using the image encoding apparatus and the image decoding apparatus according to the present invention.

As shown in FIG. 31, a cell phone 400 includes a main control unit 450 that performs overall control of units of the cell phone 400, a power supply circuit unit 451, an operation input control unit 452, an image encoder 453, a camera I/F unit 454, an LCD control unit 455, an image decoder 456, a multiplexer/demultiplexer unit 457, a recording and reproduction unit 462, a modulation and demodulation circuit unit 458, and a sound codec 459. These units are connected to one another via a bus 460.

The cell phone 400 further includes an operation key 419, a CCD (Charge Coupled Devices) camera 416, a liquid crystal display 418, a storage unit 423, a transmitting and receiving circuit unit 463, an antenna 414, a microphone (MIC) 421, and a speaker 417.

When call-ending is performed through a user operation or a power key is turned on, the power supply circuit unit 451 supplies the power from a battery pack to each unit. Thus, the cell phone 400 becomes operable.

Under the control of the main control unit 450 including a CPU, a ROM, and a RAM, the cell phone 400 performs a variety of operations, such as transmitting and receiving a voice signal, transmitting and receiving an e-mail and image data, image capturing, and data recording, in a variety of modes, such as a voice communication mode and a data communication mode.

For example, in the voice communication mode, the cell phone 400 converts a voice signal collected by the microphone (MIC) 421 into digital voice data using the sound codec 459. Thereafter, the cell phone 400 performs a spread spectrum process on the digital voice data using the modulation and demodulation circuit unit 458 and performs a digital-to-analog conversion process and a frequency conversion process on the digital voice data using the transmitting and receiving circuit unit 463. The cell phone 400 transmits a transmission signal obtained through the conversion process to a base station (not shown) via the antenna 414. The transmission signal (the voice signal) transmitted to the base station is supplied to a cell phone of a communication partner via a public telephone network.

In addition, for example, in the voice communication mode, the cell phone 400 amplifies a reception signal received by the antenna 414 using the transmitting and receiving circuit unit 463 and further performs a frequency conversion process and an analog-to-digital conversion process on the reception signal. The cell phone 400 further performs an inverse spread spectrum process on the reception signal using the modulation and demodulation circuit unit 458 and converts the reception signal into an analog voice signal using the sound codec 459. Thereafter, the cell phone 400 outputs the converted analog voice signal from the speaker 417.

Furthermore, for example, upon sending an e-mail in the data communication mode, the cell phone 400 receives text data of an e-mail input through operation of the operation key 419 using the operation input control unit 452. Thereafter, the cell phone 400 processes the text data using the main control unit 450 and displays the text data on the liquid crystal display 418 via the LCD control unit 455 in the form of an image.

Still furthermore, the cell phone 400 generates, using the main control unit 450, e-mail data on the basis of the text data and the user instruction received by the operation input control unit 452. Thereafter, the cell phone 400 performs a spread spectrum process on the e-mail data using the modulation and demodulation circuit unit 458 and performs a digital-to-analog conversion process and a frequency conversion process using the transmitting and receiving circuit unit 463. The cell phone 400 transmits a transmission signal obtained through the conversion processes to a base station (not shown) via the antenna 414. The transmission signal (the e-mail) transmitted to the base station is supplied to a predetermined address via a network and a mail server.

In addition, for example, in order to receive an e-mail in the data communication mode, the cell phone 400 receives a signal transmitted from the base station via the antenna 414 using the transmitting and receiving circuit unit 463, amplifies the signal, and further performs a frequency conversion process and an analog-to-digital conversion process on the signal. The cell phone 400 performs an inverse spread spectrum process on the reception signal and restores the original e-mail data using the modulation and demodulation circuit unit 458. The cell phone 400 displays the restored e-mail data on the liquid crystal display 418 via the LCD control unit 455.

Furthermore, the cell phone 400 can record (store) the received e-mail data in the storage unit 423 via the recording and reproduction unit 462.

The storage unit 423 can be formed from any rewritable storage medium. For example, the storage unit 423 may be formed from a semiconductor memory, such as a RAM or an internal flash memory, a hard disk, or a removable memory, such as a magnetic disk, a magnetooptical disk, an optical disk, a USB memory, or a memory card. However, it should be appreciated that another type of storage medium can be employed.

Still furthermore, in order to transmit image data in the data communication mode, the cell phone 400 generates image data through an image capturing operation performed by the CCD camera 416. The CCD camera 416 includes optical devices, such as a lens and an aperture, and a CCD serving as a photoelectric conversion element. The CCD camera 416 captures the image of a subject, converts the intensity of the received light into an electrical signal, and generates the image data of the subject image. The CCD camera 416 supplies the image data to the image encoder 453 via the camera I/F unit 454. The image encoder 453 compression-encodes the image data using a predetermined coding standard, such as MPEG2 or MPEG4, and converts the image data into encoded image data.

The cell phone 400 employs the above-described image encoding apparatus 151 or 251 as the image encoder 453 that performs such a process. Accordingly, like the image encoding apparatus 151 or 251, the image encoder 453 performs not only motion compensation but also blur compensation in inter prediction. Thus, even when blur appears or disappears between an image to be inter predicted and the reference image, the inter prediction can be performed more accurately. As a result, the quality of the inter predicted image can be increased.

Note that at the same time, the cell phone 400 analog-to-digital converts the sound collected by the microphone (MIC) 421 during the image capturing operation performed by the CCD camera 416 using the sound codec 459 and further performs an encoding process.

The cell phone 400 multiplexes, using the multiplexer/demultiplexer unit 457, the encoded image data supplied from the image encoder 453 with the digital sound data supplied from the sound codec 459 using a predetermined technique. The cell phone 400 performs a spread spectrum process on the resultant multiplexed data using the modulation and demodulation circuit unit 458 and performs a digital-to-analog conversion process and a frequency conversion process using the transmitting and receiving circuit unit 463. The cell phone 400 transmits a transmission signal obtained through the conversion processes to the base station (not shown) via the antenna 414. The transmission signal (the image data) transmitted to the base station is supplied to a communication partner via, for example, the network.

Note that if image data is not transmitted, the cell phone 400 can display the image data generated by the CCD camera 416 on the liquid crystal display 418 via the LCD control unit 455 without using the image encoder 453.

In addition, for example, in order to receive the data of a moving image file linked to, for example, a simplified Web page in the data communication mode, the cell phone 400 receives a signal transmitted from the base station via the antenna 414 using the transmitting and receiving circuit unit 463, amplifies the signal, and further performs a frequency conversion process and a digital-to-analog conversion process on the signal. The cell phone 400 performs an inverse spread spectrum process on the reception signal using the modulation and demodulation circuit unit 458 and restores the original multiplexed data. The cell phone 400 demultiplexes the multiplexed data into the encoded image data and sound data using the multiplexer/demultiplexer unit 457.

By decoding the encoded image data in the image decoder 456 using a decoding technique corresponding to a predetermined encoding standard, such as MPEG2 or MPEG4, the cell phone 400 can generate reproduction image data and displays the reproduction image data on the liquid crystal display 418 via the LCD control unit 455. Thus, for example, moving image data included in a moving image file linked to a simplified Web page can be displayed on the liquid crystal display 418.

The cell phone 400 employs the above-described image decoding apparatus 201 or 281 as the image decoder 456 that performs such a process. Accordingly, like the image decoding apparatus 201 or 281, the image decoder 456 performs not only motion compensation but also the blur compensation in inter prediction. Thus, even when blur appears or disappears between an image to be inter predicted and the reference image, the inter prediction can be performed more accurately. As a result, the quality of the inter predicted image can be increased.

At the same time, the cell phone 400 converts the digital sound data into an analog sound signal using the sound codec 459 and outputs the analog sound signal from the speaker 417. In this way, for example, the sound data included in the moving image file linked to the simplified Web page can be reproduced.

Note that as in the case of an e-mail, the cell phone 400 can record (store) the data linked to, for example, a simplified Web page in the storage unit 423 via the recording and reproduction unit 462.

In addition, the cell phone 400 can analyze a two-dimensional code obtained through an image capturing operation performed by the CCD camera 416 using the main control unit 450 and acquire the information recorded as the two-dimensional code.

Furthermore, the cell phone 400 can communicate with an external device using an infrared communication unit 481 and infrared light.

By using the image encoding apparatus 151 or 251 as the image encoder 453, the cell phone 400 can increase the coding efficiency for encoding, for example, the image data generated by the CCD camera 416 and generating encoded data. As a result, the cell phone 400 can provide encoded data (image data) with excellent coding efficiency to another apparatus.

In addition, by using the image decoding apparatus 201 or 281 as the image decoder 456, the cell phone 400 can generate a high-accuracy predicted image. As a result, the cell phone 400 can acquire a higher-resolution decoded image from a moving image file linked to a simplified Web page and display the higher-resolution decoded image.

Note that while the above description has been made with reference to the cell phone 400 using the CCD camera 416, an image sensor using a CMOS (Complementary Metal Oxide Semiconductor) (i.e., a CMOS image sensor) may be used instead of the CCD camera 416. Even in such a case, as in the case of using the CCD camera 416, the cell phone 400 can capture the image of a subject and generate the image data of the image of the subject.

In addition, while the above description has been made with reference to the cell phone 400, the image encoding apparatus 151 or 251 and the image decoding apparatus 201 or 281 can be applied to any apparatus having an image capturing function and a communication function similar to those of the cell phone 400, such as a PDA (Personal Digital Assistant), a smart phone, a UMPC (Ultra Mobile Personal Computer), a netbook, or a laptop personal computer, as to the cell phone 400.

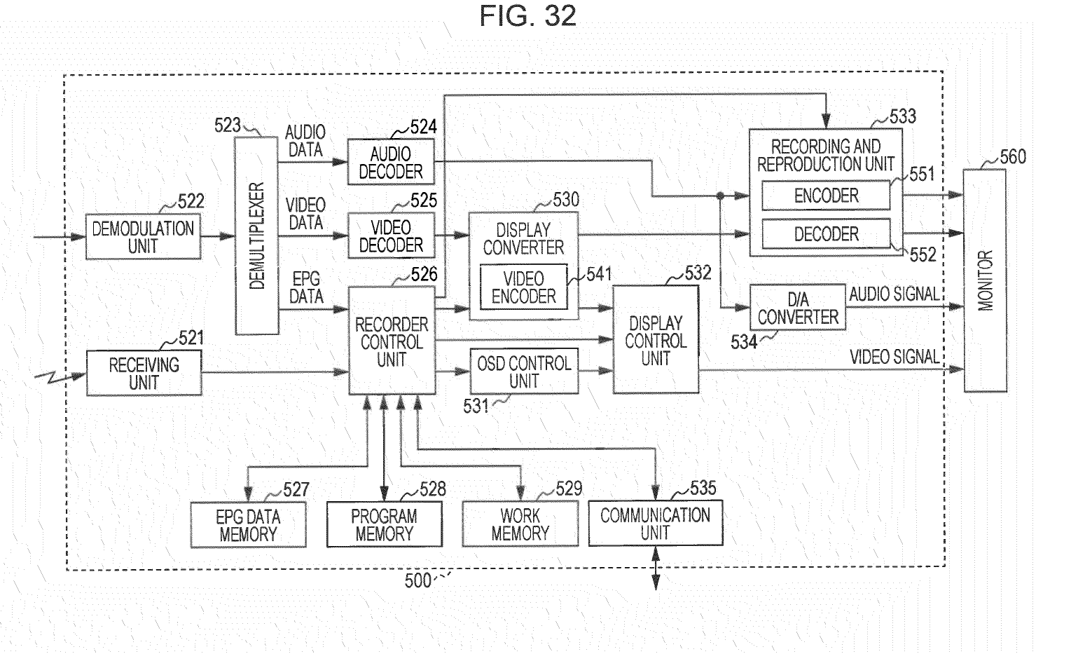

FIG. 32 is a block diagram of an example of the primary configuration of a hard disk recorder using the image encoding apparatus and the image decoding apparatus according to the present invention.

As shown in FIG. 32, a hard disk recorder (HDD recorder) 500 stores, in an internal hard disk, audio data and video data of a broadcast program included in a broadcast signal (a television program) emitted from, for example, a satellite or a terrestrial antenna and received by a tuner. Thereafter, the hard disk recorder 500 provides the stored data to a user at a timing instructed by the user.

The hard disk recorder 500 can extract audio data and video data from, for example, the broadcast signal, decode the data as needed, and store the data in the internal hard disk. In addition, the hard disk recorder 500 can acquire audio data and video data from another apparatus via, for example, a network, decode the data as needed, and store the data in the internal hard disk.

Furthermore, the hard disk recorder 500 can decode audio data and video data stored in, for example, the internal hard disk and supply the decoded audio data and video data to a monitor 560. Thus, the image can be displayed on the screen of the monitor 560. In addition, the hard disk recorder 500 can output the sound from a speaker of the monitor 560.

For example, the hard disk recorder 500 decodes audio data and video data extracted from the broadcast signal received via the tuner or audio data and video data acquired from another apparatus via a network. Thereafter, the hard disk recorder 500 supplies the decoded audio data and video data to the monitor 560, which displays the image of the video data on the screen of the monitor 560. In addition, the hard disk recorder 500 can output the sound from the speaker of the monitor 560.

It should be appreciated that the hard disk recorder 500 can perform other operations.

As shown in FIG. 32, the hard disk recorder 500 includes a receiving unit 521, a demodulation unit 522, a demultiplexer 523, an audio decoder 524, a video decoder 525, and a recorder control unit 526. The hard disk recorder 500 further includes an EPG data memory 527, a program memory 528, a work memory 529, a display converter 530, an OSD (On Screen Display) control unit 531, a display control unit 532, a recording and reproduction unit 533, a D/A converter 534, and a communication unit 535.

Furthermore, the display converter 530 includes a video encoder 541. The recording and reproduction unit 533 includes an encoder 551 and a decoder 552.

The receiving unit 521 receives an infrared signal transmitted from a remote controller (not shown) and converts the infrared signal into an electrical signal. Thereafter, the receiving unit 521 outputs the electrical signal to the recorder control unit 526. The recorder control unit 526 is formed from, for example, a microprocessor. The recorder control unit 526 performs a variety of processes in accordance with a program stored in the program memory 528. At that time, the recorder control unit 526 uses the work memory 529 as needed.

The communication unit 535 is connected to a network and performs a communication process with another apparatus connected thereto via the network. For example, the communication unit 535 is controlled by the recorder control unit 526 and communicates with a tuner (not shown). The communication unit 535 mainly outputs a channel selection control signal to the tuner.

The demodulation unit 522 demodulates the signal supplied from the tuner and outputs the demodulated signal to the demultiplexer 523. The demultiplexer 523 demultiplexes the data supplied from the demodulation unit 522 into audio data, video data, and EPG data and outputs these data items to the audio decoder 524, the video decoder 525, and the recorder control unit 526, respectively.

The audio decoder 524 decodes the input audio data using, for example, the MPEG standard and outputs the decoded audio data to the recording and reproduction unit 533. The video decoder 525 decodes the input video data using, for example, the MPEG standard and outputs the decoded video data to the display converter 530. The recorder control unit 526 supplies the input EPG data to the EPG data memory 527, which stores the EPG data.

The display converter 530 encodes the video data supplied from the video decoder 525 or the recorder control unit 526 into, for example, NTSC (National Television Standards Committee) video data using the video encoder 541 and outputs the encoded video data to the recording and reproduction unit 533. In addition, the display converter 530 converts the screen size for the video data supplied from the video decoder 525 or the recorder control unit 526 into a size corresponding to the size of the monitor 560. The display converter 530 further converts the video data having the converted screen size into NTSC video data using the video encoder 541 and converts the video data into an analog signal. Thereafter, the display converter 530 outputs the analog signal to the display control unit 532.

Under the control of the recorder control unit 526, the display control unit 532 overlays an OSD signal output from the OSD (On Screen Display) control unit 531 on a video signal input from the display converter 530 and outputs the overlaid signal to the monitor 560, which displays the image.

In addition, the audio data output from the audio decoder 524 is converted into an analog signal by the D/A converter 534 and is supplied to the monitor 560. The monitor 560 outputs the audio signal from a speaker incorporated therein.

The recording and reproduction unit 533 includes a hard disk serving as a storage medium for recording video data and audio data.

For example, the recording and reproduction unit 533 MPEG-encodes the audio data supplied from the audio decoder 524 using the encoder 551. In addition, the recording and reproduction unit 533 MPEG-encodes the video data supplied from the video encoder 541 of the display converter 530 using the encoder 551. The recording and reproduction unit 533 multiplexes the encoded audio data with the encoded video data using a multiplexer so as to synthesize the data. The recording and reproduction unit 533 amplifies the synthesized data by channel coding and writes the data into the hard disk via a recording head.

The recording and reproduction unit 533 reproduces the data recorded in the hard disk via a reproducing head, amplifies the data, and separates the data into audio data and video data using the demultiplexer. The recording and reproduction unit 533 MPEG-decodes the audio data and video data using the decoder 552. The recording and reproduction unit 533 D/A-converts the decoded audio data and outputs the converted audio data to the speaker of the monitor 560. In addition, the recording and reproduction unit 533 D/A-converts the decoded video data and outputs the converted video data to the display of the monitor 560.

The recorder control unit 526 reads the latest EPG data from the EPG data memory 527 in response to a user instruction indicated by an infrared signal emitted from the remote controller and received via the receiving unit 521. Thereafter, the recorder control unit 526 supplies the EPG data to the OSD control unit 531. The OSD control unit 531 generates image data corresponding to the input EPG data and outputs the image data to the display control unit 532. The display control unit 532 outputs the video data input from the OSD control unit 531 to the display of the monitor 560, which displays the video data. In this way, the EPG (electronic program guide) is displayed on the display of the monitor 560.

In addition, the hard disk recorder 500 can acquire a variety of types of data, such as video data, audio data, or EPG data, supplied from a different apparatus via a network, such as the Internet.

The communication unit 535 is controlled by the recorder control unit 526. The communication unit 535 acquires encoded data, such as video data, audio data, and EPG data, transmitted from a different apparatus via a network and supplies the encoded data to the recorder control unit 526. The recorder control unit 526 supplies, for example, the acquired encoded video data and audio data to the recording and reproduction unit 533, which stores the data in the hard disk. At that time, the recorder control unit 526 and the recording and reproduction unit 533 may re-encode the data as needed.

In addition, the recorder control unit 526 decodes the acquired encoded video data and audio data and supplies the resultant video data to the display converter 530. In the same manner for the video data supplied from the video decoder 525, the display converter 530 processes the video data supplied from the recorder control unit 526 and supplies the video data to the monitor 560 via the display control unit 532 so that the image is displayed.

In addition, at the same time as displaying the image, the recorder control unit 526 may supply the decoded audio data to the monitor 560 via the D/A converter 534 and output the sound from the speaker.

Furthermore, the recorder control unit 526 decodes the acquired encoded EPG data and supplies the decoded EPG data to the EPG data memory 527.

The above-described hard disk recorder 500 uses the image decoding apparatus 201 or 281 as each of the decoders included in the video decoder 525, the decoder 552, and the recorder control unit 526. Accordingly, like the image decoding apparatus 201 or 281, the decoder included in each of the video decoder 525, the decoder 552, and the recorder control unit 526 performs not only motion compensation but also blur compensation in inter prediction. Thus, even when blur appears or disappears between the image to be inter predicted and the reference image, inter prediction can be performed more accurately. As a result, the quality of the inter predicted image can be increased.

Therefore, the hard disk recorder 500 can generate a high-accuracy predicted image. As a result, the hard disk recorder 500 can acquire a higher-resolution decoded image from encoded video data received via the tuner, encoded video data read from the hard disk of the recording and reproduction unit 533, or encoded video data acquired via the network and display the higher-resolution decoded image on the monitor 560.

In addition, the hard disk recorder 500 uses the image encoding apparatus 151 or 251 as the encoder 551. Accordingly, like the image encoding apparatus 151 or 251, the encoder 551 performs not only motion compensation but also blur compensation in inter prediction. Thus, even when blur appears or disappears between the image to be inter predicted and the reference image, inter prediction can be performed more accurately. As a result, the quality of the inter predicted image can be increased.

Accordingly, for example, the hard disk recorder 500 can increase the coding efficiency for the encoded data stored in the hard disk. As a result, the hard disk recorder 500 can use the storage area of the hard disk more efficiently.

Note that while the above description has been made with reference to the hard disk recorder 500 that records video data and audio data in the hard disk, it should be appreciated that any recording medium can be employed. For example, like the above-described hard disk recorder 500, the image encoding apparatus 151 or 251 and the image decoding apparatus 201 or 281 can be applied to even a recorder that uses a recording medium other than a hard disk (e.g., a flash memory, an optical disk, or a video tape).

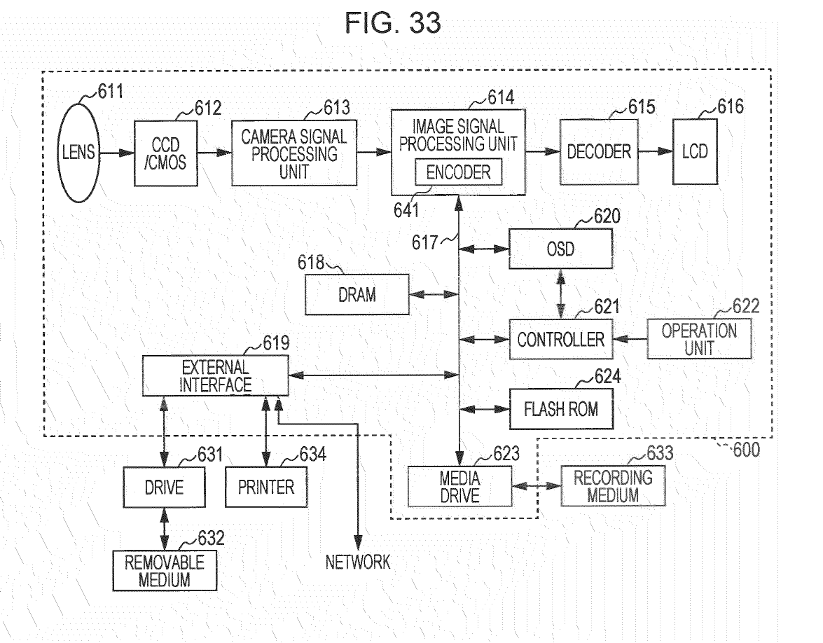

FIG. 33 is a block diagram of an example of the primary configuration of a camera using the image decoding apparatus and the image encoding apparatus according to the present invention.

A camera 600 shown in FIG. 33 captures the image of a subject and instructs an LCD 616 to display the image of the subject thereon or stores the image in a recording medium 633 in the form of image data.

A lens block 611 causes the light (i.e., the video of the subject) to be incident on a CCD/CMOS 612. The CCD/CMOS 612 is an image sensor using a CCD or a CMOS. The CCD/CMOS 612 converts the intensity of the received light into an electrical signal and supplies the electrical signal to a camera signal processing unit 613.

The camera signal processing unit 613 converts the electrical signal supplied from the CCD/CMOS 612 into Y, Cr, Cb color difference signals and supplies the color difference signals to an image signal processing unit 614. Under the control of a controller 621, the image signal processing unit 614 performs a predetermined image process on the image signal supplied from the camera signal processing unit 613 or encodes the image signal using an encoder 641 and, for example, the MPEG standard. The image signal processing unit 614 supplies encoded data generated by encoding the image signal to a decoder 615. In addition, the image signal processing unit 614 acquires display data generated by an on screen display (OSD) 620 and supplies the display data to the decoder 615.

In the above-described processing, the camera signal processing unit 613 uses a DRAM (Dynamic Random Access Memory) 618 connected thereto via a bus 617 as needed and stores, in the DRAM 618, encoded data obtained by encoding the image data as needed.

The decoder 615 decodes the encoded data supplied from the image signal processing unit 614 and supplies the resultant image data (the decoded image data) to the LCD 616. In addition, the decoder 615 supplies the display data supplied from the image signal processing unit 614 to the LCD 616. The LCD 616 combines an image of the decoded image data supplied from the decoder 615 with an image of the display data as needed and displays the combined image.

Under the control of the controller 621, the on screen display 620 outputs the display data, such as a menu screen including symbols, characters, or graphics and icons, to the image signal processing unit 614 via the bus 617.

The controller 621 performs a variety of types of processing on the basis of a signal indicating a user instruction input through the operation unit 622 and controls the image signal processing unit 614, the DRAM 618, an external interface 619, the on screen display 620, and a media drive 623 via the bus 617. A FLASH ROM 624 stores a program and data necessary for the controller 621 to perform the variety of types of processing.

For example, the controller 621 can encode the image data stored in the DRAM 618 and decode the encoded data stored in the DRAM 618 instead of the image signal processing unit 614 and the decoder 615. At that time, the controller 621 may perform the encoding/decoding process using the encoding/decoding method employed by the image signal processing unit 614 and the decoder 615. Alternatively, the controller 621 may perform the encoding/decoding process using an encoding/decoding method different from that employed by the image signal processing unit 614 and the decoder 615.

In addition, for example, when instructed to print an image from the operation unit 622, the controller 621 reads the encoded data from the DRAM 618 and supplies, via the bus 617, the encoded data to a printer 634 connected to the external interface 619 via the external interface 619. Thus, the image data is printed.

Furthermore, for example, when instructed to record an image from the operation unit 622, the controller 621 reads the encoded data from the DRAM 618 and supplies, via the bus 617, the encoded data to the recording medium 633 mounted in the media drive 623. Thus, the image data is stored in the recording medium 633.

Examples of the recording medium 633 include readable and writable removable media, such as a magnetic disk, a magnetooptical disk, an optical disk, and a semiconductor memory. It should be appreciated that the recording medium 633 is of any removable medium type, such as a tape device, a disk, or a memory card. Alternatively, the recording medium 633 may be a non-contact IC card.

Alternatively, the media drive 623 may be integrated into the recording medium 633. For example, like an internal hard disk drive or an SSD (Solid State Drive), a non-removable storage medium can be used as the media drive 623 and the recording medium 633.

The external interface 619 is formed from, for example, a USB input/output terminal. When an image is printed, the external interface 619 is connected to the printer 634. In addition, a drive 631 is connected to the external interface 619 as needed. Thus, a removable medium 632, such as a magnetic disk, an optical disk, or a magnetooptical disk, is mounted as needed. A computer program read from the removable medium 632 is installed in the FLASH ROM 624 as needed.

Furthermore, the external interface 619 includes a network interface connected to a predetermined network, such as a LAN or the Internet. For example, in response to an instruction received from the operation unit 622, the controller 621 can read the encoded data from the DRAM 618 and supply the encoded data from the external interface 619 to another apparatus connected thereto via the network. In addition, the controller 621 can acquire, using the external interface 619, encoded data and image data supplied from another apparatus via the network and store the data in the DRAM 618 or supply the data to the image signal processing unit 614.

The above-described camera 600 uses the image decoding apparatus 201 or 281 as the decoder 615. Accordingly, like the image decoding apparatus 201 or 281, the decoder 615 performs not only motion compensation but also blur compensation in the inter prediction. In this way, inter prediction can be performed more accurately even when blur appears or disappears between an image to be inter predicted and the reference image. Thus, the quality of an inter predicted image can be increased.

Therefore, the camera 600 can generate a high-accuracy predicted image. As a result, the camera 600 can acquire a higher-resolution decoded image from, for example, the image data generated by the CCD/CMOS 612, the encoded data of video data read from the DRAM 618 or the recording medium 633, or the encoded data of video data received via a network and display the decoded image on the LCD 616.

In addition, the camera 600 uses the image encoding apparatus 151 or 251 as the encoder 641. Accordingly, like the image encoding apparatus 151 or 251, the encoder 641 performs not only motion compensation but also blur compensation in the inter prediction. In this way, inter prediction can be performed more accurately even when blur appears or disappears between an image to be inter predicted and the reference image. Thus, the quality of an inter predicted image can be increased.

Accordingly, for example, the camera 600 can increase the coding efficiency for the encoded data stored in the hard disk. As a result, the camera 600 can use the storage area of the DRAM 618 and the storage area of the recording medium 633 more efficiently.

Note that the decoding technique employed by the image decoding apparatus 201 or 281 may be applied to the decoding process performed by the controller 621. Similarly, the encoding technique employed by the image encoding apparatus 151 or 251 may be applied to the encoding process performed by the controller 621.

In addition, the image data captured by the camera 600 may be a moving image or a still image.

It should be appreciated that the image encoding apparatus 151 or 251 and the image decoding apparatus 201 or 281 are applicable to apparatuses or systems other than the above-described apparatuses.

### REFERENCE SIGNS LIST

63, 70, 115 computing unit
67 accumulation buffer
151 image encoding apparatus
161 motion prediction/compensation unit
162 blur prediction/compensation unit
171 blur compensation unit
172 blur prediction unit
201 image decoding apparatus
212 motion prediction/compensation unit
213 blur prediction/compensation unit
221 filter coefficient conversion unit
251 image encoding apparatus
261 blur motion prediction/compensation unit
281 image decoding apparatus
282 blur motion prediction/compensation unit

1. An image processing apparatus comprising:
decoding means for decoding an encoded image;
compensating means for performing motion compensation and blur compensation on the image decoded by the decoding means on the basis of blur information indicating a variation in blur between images, the blur information corresponding to the encoded image and transmitted from a different image processing apparatus that has encoded the image; and
computing means for generating a decoded image by summing the image decoded by the decoding means and a compensated image subjected to motion compensation and blur compensation performed by the compensating means.

2. The image processing apparatus according to claim 1, wherein the blur information is expressed by a PSF (Point Spread Function).

3. The image processing apparatus according to claim 1, wherein the blur information is expressed using a two-dimensional normal distribution expression.

4. The image processing apparatus according to claim 3, wherein the blur information transmitted from a different image processing apparatus indicates a spreading width W of the two-dimensional normal distribution expression.

5. The image processing apparatus according to claim 1, wherein the blur information is expressed by a radius L output as an impulse response.

6. The image processing apparatus according to claim 10, wherein the blur information is expressed by a length Lx in a horizontal direction and a length Ly in a vertical direction from a center as an impulse response.

7. The image processing apparatus according to claim 1, wherein the compensating means performs the motion compensation on the image decoded by the decoding means and performs the blur compensation on the resultant image using the blur information.

8. The image processing apparatus according to claim 1, wherein the compensating means performs the blur compensation on the image decoded by the decoding means using the blur information and performs the motion compensation on the resultant image.

9. An image processing method for use in an image processing apparatus, comprising:
a decoding step of decoding an encoded image;
a compensating step of performing motion compensation and blur compensation on the image decoded in the decoding step on the basis of blur information indicating a variation in blur between images, the blur information corresponding to the encoded image and transmitted from a different image processing apparatus that has encoded the image; and
a computing step of generating a decoded image by summing the image decoded in the decoding step and a compensated image subjected to motion compensation and blur compensation performed in the compensating step.

10. A program comprising:
program code for causing a computer to function as an image processing apparatus, the image processing apparatus including decoding means for decoding an encoded image, compensating means for performing motion compensation and blur compensation on the image decoded by the decoding means on the basis of blur information indicating a variation in blur between images, where the blur information corresponds to the encoded image and is transmitted from a different image processing apparatus that has encoded the image, and computing means for generating a decoded image by summing the image decoded by the decoding means and a compensated image subjected to motion compensation and blur compensation performed by the compensating means.

11. An image processing apparatus comprising:
compensating means for predicting, using an image to be encoded and a reference image, motion and a variation in blur between the image to be encoded and the reference image and performing motion compensation and blur compensation on the reference image on the basis of a motion vector representing the motion and blur information indicating the variation in blur;
encoding means for generating an encoded image using a difference between a compensated image subjected to the motion compensation and the blur compensation and the image to be encoded; and
transmitting means for transmitting the encoded image and the blur information.

12. The image processing apparatus according to claim 11, wherein the blur information is expressed by a PSF (Point Spread Function).

13. The image processing apparatus according to claim 11, wherein the blur information is expressed using a two-dimensional normal distribution expression.

14. The image processing apparatus according to claim 13, wherein the transmitting means transmits a spreading width W of the two-dimensional normal distribution expression as the blur information.

15. The image processing apparatus according to claim 11, wherein the blur information is expressed by a radius L output as an impulse response.

16. The image processing apparatus according to claim 11, wherein the blur information is expressed by a length Lx in a horizontal direction and a length Ly in a vertical direction from a center as an impulse response.

17. The image encoding apparatus according to claim 11, wherein the compensating means predicts the motion using the image to be encoded and the reference image and performs the motion compensation on the basis of a motion vector representing the motion, and wherein the compensating means predicts the variation in blur using the image obtained through the motion compensation and the image to be encoded and performs the blur compensation on the basis of blur information indicating the variation in blur.

18. The image encoding apparatus according to claim 11, wherein the compensating means predicts the variation in blur using the image to be encoded and the reference image and performs the blur compensation on the basis of blur information indicating the variation in blur, and wherein the compensating means predicts the motion using the image obtained through the blur compensation and the image to be encoded and performs the motion compensation on the basis of a motion vector representing the motion.

19. An image processing method for use in an image processing apparatus, comprising:
a compensating step of predicting, using an image to be encoded and a reference image, motion and a variation in blur between the image to be encoded and the reference image and performing motion compensation and blur compensation on the basis of a motion vector representing the motion and blur information indicating the variation in blur;
an encoding step of generating an encoded image using a difference between a compensated image subjected to the motion compensation and the blur compensation and the image to be encoded; and
a transmitting step of transmitting the encoded image and the blur information.

20. A program comprising:
program code for causing a computer to function as an image processing apparatus, the image processing apparatus including compensating means for predicting, using an image to be encoded and a reference image, motion and a variation in blur between the image to be encoded and the reference image and performing motion compensation and blur compensation on the basis of a motion vector representing the motion and blur information indicating the variation in blur, encoding means for generating an encoded image using a difference between a compensated image subjected to the motion compensation and the blur compensation and the image to be encoded, and transmitting means for transmitting the encoded image and the blur information.
